(19) United States
(12) Patent Application Publication
(10) Pub. No.: US 2026/0340744 A1
(43) Pub. Date: Oct. 29, 2026

(54) ELECTRONIC PROPOSAL SOLICITATION PROCESSES WITH ARTIFICIAL INTELLIGENCE AND/OR BLOCKCHAIN INTEGRATIONS

(71) Applicant: BJustCoin IP Holding LLC, Sheridan, WY (US)

(72) Inventor: Beatrice T. O'Brien, Short Hills, NJ (US)

(21) Appl. No.: 19/191,274

(22) Filed: Apr. 28, 2025

(51) Int. Cl. G06Q 50/18; G06F 40/289

(52) U.S. Cl. CPC G06Q 50/18; G06F 40/289

(57) ABSTRACT

This disclosure is related to improved systems, methods, and techniques for electronic proposal solicitations using artificial intelligence (AI) and/or blockchain integrations. In certain embodiments, one or more deep learning networks or language models can be applied to automate or streamline the generation of request specifications and response proposals corresponding to the request specifications, as well as to execute candidate matching and ranking functions for the request specifications. In certain embodiments, various event data corresponding to the proposal solicitation processes can be recorded on one or more blockchain networks to record the activities in an immutable fashion.

### TECHNICAL FIELD

This disclosure is related to improved systems, methods, and techniques for soliciting proposals using artificial intelligence (AI) and/or blockchain integrations. In certain embodiments, one or more deep learning networks or large language models (LLMs) can be applied to automate or streamline the generation of request specifications and response proposals corresponding to the request specifications, as well as to execute candidate matching and ranking functions for the request specifications. In certain embodiments, various network activities corresponding to the processing of request specifications and the solicitation of response proposals can be recorded on one or more blockchain networks to record the activities in an immutable fashion.

### BACKGROUND

Traditional solutions for implementing requests for proposals (RFPs) are plagued with inefficiencies. A typical RFP process flow involves several stages, including a first stage that involves the creation of an RFP specification, a second stage that involves researching and selecting service providers to receive the specification, a third stage that involves each service provider generating a separate proposal for responding to the specification, and fourth stage that involves reviewing the proposals and selecting the proposal that is best aligned with the RFP objectives or requirements.

Conventional approaches for implementing these solicitation processes typically rely on manual efforts at each of the aforementioned stages, which can be time-consuming, labor-intensive, and prone to human error. Additionally, the reliance on manual efforts often interjects human bias into various stages of the solicitation process, hindering an objective analysis of service providers, which can result in the selection of suboptimal service providers to fulfill the RFP objectives or goals.

Other types of request specifications, such as those corresponding to requests for quotations (RFQs), requests for information (RFIs), and/or role placement requests, can include the same or similar stages. Similar to traditional RFP processes, these request specifications predominantly depend on manual drafting and review, resulting in the same inefficiencies and challenges outlined above.

The lack of automation and reliance on manual efforts throughout the solicitation processes can impact the overall quality or performance of the solicitation processes and can result in the selection of suboptimal service providers to fulfill the request specifications. However, efforts to incorporate automation and eliminate bias from traditional solicitation processes face various technical challenges.

In the first stage of a solicitation process, a poorly drafted request specification can poison downstream stages and can undermine the ability of service providers to submit meaningful responses, as critical information needed by the requesting end-user to make an informed decision may be omitted or inadequately conveyed. One of the technical challenges with attempts to automate the creation of a request specification lies in the highly variable nature of content, which can differ substantially depending on the type of proposal being solicited. For instance, a properly prepared RFP for a litigation matter may include entirely different parameters and criteria than an RFP for a merger and acquisition (M&A) deal. Similarly, the parameters for a plaintiff in a civil infringement litigation may be starkly different from those of a defendant in the same type of case. These nuances demand a level of contextual understanding that is difficult to achieve, particularly for end-users who lack experience in drafting RFPs for specific types of matters. Adding to the complexity, the RFP requesters often introduce unique criteria that are specific to a project, such as specific fee arrangements, geographic proximity requirements, compatibility with certain technological systems (e.g., such as e-discovery or other legal tech solutions that are used by the requesting entity).

Accounting for these nuances and producing a contextually relevant request specification using an automated or semi-automated system presents significant technical challenges. Ideally, such systems should be capable of understanding the diverse requirements of different types of request specifications, identifying missing parameters, and tailoring the content to align with the specific objectives of the requesting entity—all while ensuring clarity, completeness, and consistency with best practices for specific practice areas or project types.

In the second stage of a solicitation process, which involves researching and selecting service providers to receive a request specification, additional challenges arise that can hinder the effectiveness and objectivity of the process.

One technical challenge to automate or streamline this stage of the process can be attributed to difficulties in configuring a system to adequately understand or interpret the nuanced requirements of each request specification and to holistically assess the suitability of service providers based on a wide range of relevant factors.

Additional technical challenges can relate to removing bias from the review and selection process. Human selection techniques can lack objectivity and may introduce bias into the decision-making process. This subjectivity often results in highly suitable service providers being overlooked or not considered, as the evaluation may be influenced by incomplete information, personal preferences, or limited visibility into the full pool of candidates.

Additional technical challenges can be attributed to the sheer volume of potential service providers. In many scenarios, the pool of candidates is vast, making it impractical or even impossible to manually search and evaluate the capabilities of all available options. For example, when an RFP is used to solicit services from legal service providers, there are hundreds of thousands of law firms in the United States alone. Attempting to identify the most suitable candidates from such an extensive pool without the aid of advanced tools or methodologies can be impractical or impossible. Consequently, the humans tasked with reviewing or selecting service providers to receive the request specifications often rely on “word of mouth” referrals or discussions to make these selections. These challenges underscore the need for more sophisticated, automated systems that can objectively analyze large datasets while accounting for the nuanced requirements of the RFP, and efficiently identify the most qualified service providers to receive the request specification.

In the third stage of a solicitation process, which involves each service provider drafting a response proposal to the request specification, additional challenges arise that can significantly impact the quality and efficiency of the proposals submitted. Drafting a response proposal is often a time-intensive and laborious process, requiring service providers to carefully analyze the request specification, extract relevant details, and tailor their responses to meet the specific requirements outlined by the requesting end-user. This process is further complicated by the variability and complexity of request specifications, which can differ substantially depending on the type of services being solicited and unique criteria that may be incorporated by the requesting party. Service providers must navigate these nuances while ensuring their proposals are comprehensive, accurate, and aligned with the objectives of the request specification.

Additional technical challenges emerge when gathering information to include in response proposals. For instance, while solo practitioners or small service providers can more easily compile details about prior projects relevant to a current request specification, this task becomes significantly more complex for larger enterprises with multiple office locations and thousands of employees. Although addressing the parameters of a request specification comprehensively can greatly enhance the likelihood of a successful response proposal, critical information is often overlooked or omitted during the traditional manual drafting process.

Additionally, service providers often face challenges in structuring their proposals to address unique criteria introduced by the requesting party, such as specific fee arrangements, practice area-specific requests, or technological compatibility. Addressing these requirements with a human or manual approach often necessitates extensive discussions with individuals who have domain knowledge for these specific requests. Without advanced tools or methodologies, the process of drafting response proposals can be prone to errors, inconsistencies, and omissions, which may result in proposals that fail to adequately address the needs of the requesting entity. Furthermore, the manual nature of traditional proposal drafting methods can limit the ability of service providers to efficiently produce high-quality responses, particularly when responding to multiple request specifications simultaneously. These challenges highlight the need for automated or semi-automated systems that can streamline the proposal drafting process, assist service providers in generating tailored and contextually relevant responses, and ensure alignment with the specific requirements of the request specification.

In the fourth stage of a solicitation process, which involves the requesting party reviewing the received response proposals and selecting a service provider, several challenges arise that are particularly difficult to address using automated systems. One of the primary difficulties lies in the ability of an automated system to understand or interpret the nuanced variations of response proposals that are received. Each proposal may include extensive details, such as complex pricing structures, descriptions of relevant experience, and proposed legal solutions, which can vary significantly depending on the type of services being solicited and/or the purported capabilities of the service providers. Ideally, automated systems should be capable of parsing and interpreting this diverse and unstructured data, identifying key elements, and comparing proposals across multiple dimensions. Additionally, the variability in proposal formats and content can make it challenging for automated systems to standardize the evaluation process without losing important nuances.

Another challenge lies in ensuring objectivity and impartiality during the evaluation process. Traditional manual methods often introduce subjectivity and bias, such as prioritizing pricing over equally important factors like experience or technological compatibility. While automated systems can theoretically reduce bias, implementing bias-free analysis that holistically assesses proposals based on a wide range of criteria is technically complex. Ideally, such systems should account for the relative importance of different factors, which may vary depending on the specific objectives of the request specification. Moreover, automated systems should be able to dynamically adapt to unique or custom criteria introduced by the requesting entity, such as specific fee arrangements or geographic proximity, or technology integration requirements. Achieving this level of contextual adaptability while maintaining consistency and accuracy in the evaluation process presents significant technical challenges. These difficulties underscore the need for sophisticated solutions that can streamline the review process, objectively evaluate proposals, and provide actionable insights to guide the selection of the most suitable service provider.

The background description provided herein is for the purpose of presenting the context of the disclosure. The materials described in this section are not prior art to the claims in this application and are not admitted to be prior art, or suggestions of the prior art, by inclusion in this section.

### BRIEF DESCRIPTION OF DRAWINGS

To facilitate further description of the embodiments, the following drawings are provided, in which like references are intended to refer to like or corresponding parts, and in which:

FIG. 1A is a diagram of an exemplary system in accordance with certain embodiments;

FIG. 1B is a block diagram demonstrating exemplary features of a legal service platform in accordance with certain embodiments;

FIG. 2 is a flow diagram illustrating an exemplary proposal solicitation process according to certain embodiments;

FIG. 3 is a flow diagram illustrating an exemplary specification synthesis process according to certain embodiments;

FIG. 4 is a flow diagram illustrating an exemplary matching process according to certain embodiments;

FIG. 5 is a flow diagram illustrating an exemplary proposal synthesis process according to certain embodiments; and

FIG. 6 is a flowchart illustrating an exemplary method for an electronic solicitation process in accordance with certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

As used herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Certain data or functions may be described as “real-time,” “near real-time,” or “substantially real-time” within this disclosure. Any of these terms can refer to data or functions that are processed with a humanly imperceptible delay or a minimal humanly perceptible delay. Alternatively, these terms can refer to data or functions that are processed within a specific time interval (e.g., in the order of milliseconds).

### DETAILED DESCRIPTION

The present disclosure relates to systems, methods, apparatuses, computer program products, and techniques for automating or streamlining proposal solicitation processes using deep learning, natural language processing (NLP), and/or large language model (LLM) technologies. The solutions described in this disclosure can overcome some or all of the technical challenges mentioned above, as well as other related challenges.

In certain embodiments, a legal service platform comprises an AI-powered solicitation system that leverages an artificial intelligence (AI) architecture to automate or streamline various aspects of electronic solicitation processes. In some examples, the AI architecture may comprise one or more language models, each of which incorporates a transformer neural network architecture that is trained on one or more domain-specific datasets described herein. The AI-powered solicitation system can initiate communication exchanges with the one or more language models to automate or streamline various stages of proposal solicitation processes, including a first stage that involves an automated synthesis or assembly of request specifications, a second stage that involves an automated identification or selection of service providers to receive the request specifications, a third stage that involves an automated synthesis or assembly of response proposals corresponding to the request specifications, and/or a fourth stage involves an automated evaluation and/or selection of the response proposals.

As explained below, various technical improvements can be incorporated into each stage of the electronic solicitation processes described herein. Amongst other things, specialized training procedures, including the supervised training procedures described herein, can be applied to train the language models on domain-specific datasets corresponding to proposal solicitation processes to enable the language models to more accurately understand key considerations at each stage of the proposal solicitation process and/or generate content and analyses at each stage.

In an initial stage of an electronic solicitation process that involves constructing a request specification, a specification assembly engine associated with the AI-powered solicitation system can execute a communication exchange with a language model to automate or streamline the assembly of a request specification that is tailored to specifically account for nuances in varying types of request specifications, practice areas, and/or types of service requests. The training procedures and/or dynamic prompting techniques described herein can enable the language model to accurately recognize varying types of request specifications, and integrate contextually relevant specification parameters into the specification request being assembled in a manner that aligns with best practices and avoids oversight of potentially important parameters.

In a second stage of an electronic solicitation process that involves selecting candidate service providers to receive a specification request, a matching engine associated with the AI-powered solicitation system can execute a communication exchange with a language model to perform an automated matching process that operates to identify a subset of candidate service providers that are predicted to be best-suited or well-aligned with the objectives of the specification request. In many scenarios, this matching operation can be rapidly and efficiently performed on large datasets, permitting a large number of candidate service providers to be considered. As part of the communication with the language model, the matching engine also may rank the subset of candidate service providers based on their predicted alignment with the request specification objectives.

During this matching and ranking process, the matching engine may employ a constrained contextual analysis that operates to guide the language model in selecting and prioritizing attributes from predefined categories, ensuring that the outputs of the language model remain focused, contextually relevant, and aligned with the specific requirements and objectives of the request specification. In certain embodiments, the matching engine also may employ a prioritized matching function that optimizes the identification of candidate service providers by applying a multi-tiered search strategy facilitated by the language model. The multi-tiered search strategy can initially perform direct matching queries based on parameters determined or predicted to be highly relevant, and can progressively broaden the search criteria, if necessary. This multi-tiered search strategy can significantly reduce computational resources, processing times, and/or network traffic in connection with selecting optimal candidate service providers from a large data pool.

In a third stage of an electronic solicitation process that involves generating or constructing response proposals corresponding to a request specification, a proposal synthesis engine associated with the AI-powered solicitation system can execute a communication exchange with a language model to identify and extract proposal parameters for inclusion in the response proposals and/or to generate custom content for each response proposal which is tailored specifically to the attributes, capabilities, and/or experience of a corresponding candidate service provider. Additionally, in some embodiments, the language model may incorporate data from multiple sources to more comprehensively synthesize content corresponding to the proposal parameters included in the response proposals.

In a fourth stage of an electronic solicitation process that involves evaluating response proposals corresponding to a request specification, a proposal evaluation engine associated with the AI-powered solicitation system can execute a communication exchange with a language model to evaluate or assess the response proposals received from multiple candidate service providers and/or determine their alignment with the objectives corresponding to the request specification. Additionally, in some embodiments, the proposal evaluation engine conducts a final analysis for recommending one or more of the candidate service providers and/or synthesize a summary of the response proposals (e.g., such as by describing pros and cons of the proposals and/or highlighting comparisons of the proposals across multiple dimensions).

As explained in other portions of this disclosure, the AI-powered solicitation system can leverage the capabilities of pre-trained language models in many other contexts to automate or streamline the electronic solicitation processes described herein.

The AI-powered solicitation system can be applied to enhance electronic solicitation processes for any type of request specification, and the techniques described herein can be applied to solicit response proposals for varying types of services or objectives. In some examples described herein, the AI-powered solicitation system can manage electronic solicitation processes corresponding to requests for proposals (RFPs). In other examples, the AI-powered solicitation system can manage electronic solicitation processes corresponding to requests for quotations (RFQs), requests for information (RFIs), and/or role placement requests. The technologies described herein can be applied in many other contexts as well.

The AI-powered solicitation system can be applied to enhance electronic solicitation processes across various sectors or industries. While some portions of this disclosure may describe exemplary applications that involve electronic solicitation processes corresponding to legal services, the technologies described herein can be applied to solicitation processes in any sector or industry.

In certain embodiments, the legal service platform that hosts the AI-powered solicitation system can include a decentralized network integration system that interfaces with one or more decentralized systems to provide additional benefits and advantages. In some examples, the decentralized network integration system may communicate with one or more blockchain networks to record activities associated with the electronic solicitation processes, such as activities corresponding to the initiation of the electronic solicitation processes, the dissemination of request specifications corresponding to the electronic solicitation process, and/or the selection of service providers through the electronic solicitation processes. Recording this data on a blockchain ensures an immutable and verifiable audit trail, enhancing transparency and trust among all parties involved in the solicitation process. Additionally, the decentralized nature of blockchain technology minimizes the risk of data tampering or unauthorized alterations, providing a secure and reliable record of key activities.

In some examples, the decentralized network integration system may communicate with one or more blockchain networks to implement smart contracts between requesting end-users and service providers selected for the request specifications. For example, after a response proposal is selected or approved, the selected service provider and requesting end-user can establish a smart contract on the legal service platform to memorialize and/or control obligations of their relationship. Recording smart contracts on a blockchain ensures automated execution of contractual terms, reducing administrative overhead and eliminating the need for intermediaries. Furthermore, the immutable nature of blockchain technology safeguards the integrity of the contract, preventing unauthorized modifications and fostering trust between the parties.

In certain embodiments, the decentralized network integration system can also interface with one or more distributed storage networks that operate to store documentation on the legal service platform in a decentralized fashion across a plurality of nodes. In some examples, this can include the distributed storage of documentation corresponding to the electronic solicitation processes (e.g., such as request specifications, response proposals, or other related data) and/or documentation corresponding to established smart contracts. The decentralized storage of documentation ensures enhanced data security by eliminating single points of failure and reducing the risk of unauthorized access. Additionally, the distributed nature of the storage network provides redundancy and fault tolerance, safeguarding against data loss and ensuring the integrity of stored records.

The embodiments described in this disclosure can be combined in various ways. Any aspect or feature that is described for one embodiment can be incorporated into any other embodiment mentioned in this disclosure. Moreover, any of the embodiments described herein may be hardware-based, may be software-based, or may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

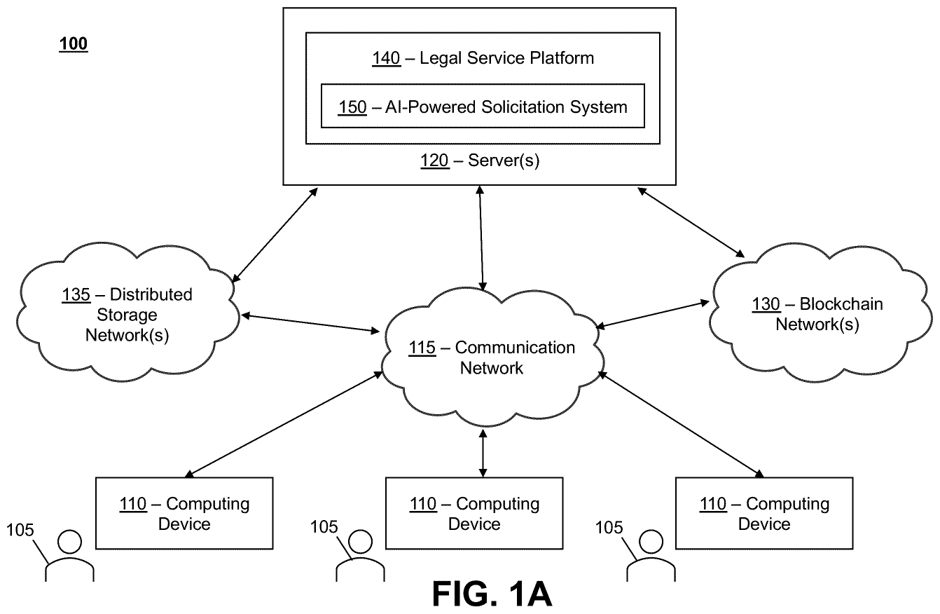

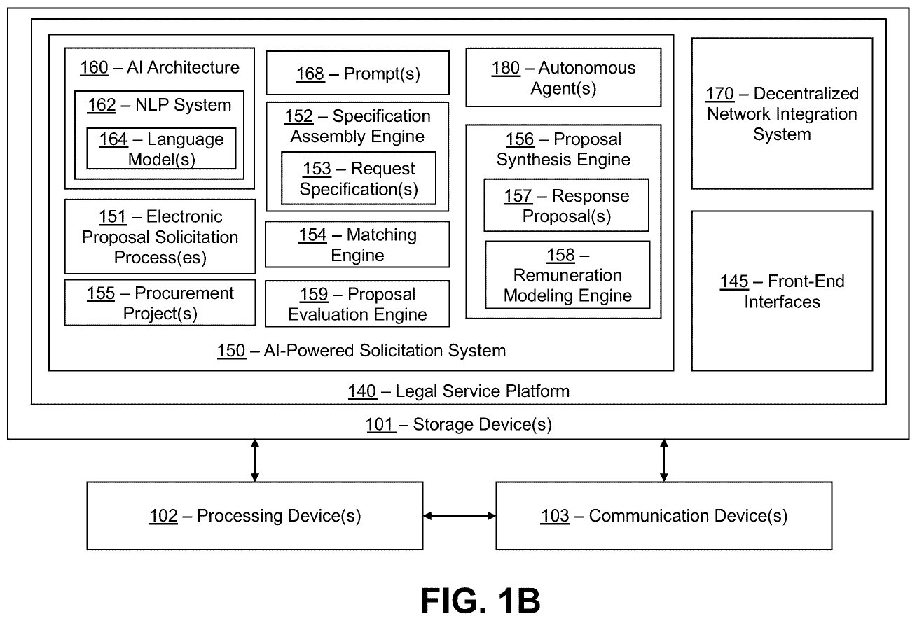

FIG. 1A is a diagram of an exemplary system 100 in accordance with certain embodiments. FIG. 1B is a diagram illustrating exemplary components, features, and/or functions associated with a legal service platform 140 and an AI-powered solicitation system 150 according to certain embodiments. FIGS. 1A and 1B are discussed jointly below.

The system 100 comprises one or more computing devices 110 and one or more servers 120 that are in communication over a communication network 115. A legal service platform 140 is stored on, and executed by, the one or more servers 120 and includes an AI-powered solicitation system 150. The communication network 115 may represent any type of communication framework or network, e.g., such as one that comprises a local area network (e.g., a Wi-Fi network), a personal area network (e.g., a Bluetooth network), a wide area network, an intranet, the Internet, a cellular network, a television network, a satellite communication network, and/or other types of networks.

The legal service platform 140, the AI-powered solicitation system 150, the one or more servers 120, and/or the one or more computing devices 110 also may communicate with the one or more blockchain networks 130. Each blockchain network 130 may include a distributed and/or decentralized system of nodes that are in communication with each other. The nodes may correspond to computing devices 110, servers 120, specialized mining devices (e.g., ASIC-based miners), and/or other types of electronic devices that include processing and/or storage capabilities. Each blockchain network 130 may store one or more distributed ledgers according to a decentralized infrastructure or protocol. The one or more distributed ledgers may be stored across the nodes of the blockchain network 130 and the nodes can be configured to execute functions associated with validating and processing transactions on the blockchain network 130, recording data corresponding to electronic proposal solicitation processes 151 on the one or more distributed ledgers, recording transactions (including, but not limited to, the transactions originating from the electronic proposal solicitation processes 151 described herein) on the one or more distributed ledgers, maintaining consensus across the blockchain network 130, executing dApps or decentralized applications (including, but not limited to, decentralized smart contract applications and/or decentralized storage applications described herein), managing network security, facilitating peer-to-peer communications, and/or other related functions.

In some embodiments, the one or more blockchain networks 130 may include the Solana blockchain network. Additionally, or alternatively, the one or more blockchain networks 130 may include the Ethereum blockchain network. Additionally, or alternatively, the one or more blockchain networks 130 may include a private or proprietary network, tailored to the specific needs or technical requirements of the platform.

The legal service platform 140, the AI-powered solicitation system 150, the one or more servers 120, and/or the one or more computing devices 110 also may communicate with the one or more distributed storage networks 135 (also referred to herein as decentralized storage networks 135). Each distributed storage network 135 may comprise a distributed or decentralized system of nodes that are in communication with each other. These nodes may correspond to computing devices 110, servers 120, and/or other types of electronic devices equipped with processing and storage capabilities. The distributed storage network 135 can be designed to store data across multiple nodes, ensuring redundancy, security, and the integrity of the stored data. The nodes within each distributed storage network 135 can execute functions associated with storing, retrieving, and managing data in a distributed manner. This can include segmenting data into smaller encrypted pieces, distributing these pieces across various nodes, and/or reconstructing the data when needed using cryptographic verification techniques. Amongst other things, the decentralized nature of the storage network enhances data integrity and security by eliminating single points of failure, preventing tampering of stored data, and reducing the risk of unauthorized access.

In some embodiments, the one or more distributed storage networks 135 can be implemented independently of a blockchain network 130 and/or blockchain technology. The one or more distributed storage networks 135 may implement a peer-to-peer (P2P) protocol, such as IPFS (InterPlanetary File System) and/or other protocols, for decentralized file storage, sharing, and/or retrieval. In other embodiments, the one or more distributed storage networks 135 can be integrated with or utilize one or more blockchain networks 130. For example, the one or more decentralized storage networks 135 may include or communicate with a blockchain network 130 to leverage functionalities for data verification, data tracking, payment, and/or authentication.

All of the components illustrated in FIG. 1A, including the computing devices 110, servers 120, blockchain networks 130 (and corresponding nodes), distributed storage networks 135 (and corresponding nodes), legal service platform 140, and/or AI-powered solicitation system 150 can be configured to communicate directly with each other and/or over the communication network 115 via wired or wireless communication links, or a combination of the two. Each of the computing devices 110, servers 120, legal service platform 140, AI-powered solicitation system 150, and/or network nodes (including any nodes associated with the blockchain networks 130 and/or distributed storage networks 135) can include one or more storage devices 101, one or more processing devices 102, and/or one or more communication devices 103.

The one or more storage devices 101 may include (i) non-volatile memory, such as, for example, read-only memory (ROM) and/or (ii) volatile memory, such as, for example, random access memory (RAM). The non-volatile memory may be removable and/or non-removable non-volatile memory. RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the one or more storage devices 101 include physical, non-transitory mediums. The one or more computer storage devices 101 can store instructions for implementing any of the functionalities associated with the legal service platform 140 and/or AI-powered solicitation system 150 described in this disclosure.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more storage devices 101 including, but not limited to, instructions associated with executing the functionalities of the legal service platform 140 and/or AI-powered solicitation system 150 described in this disclosure.

Each of the one or more communication devices 103 can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as Wi-Fi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices 103 also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices 103 additionally, or alternatively, can include one or more modem devices, one or more router devices, one or more access points, and/or one or more mobile hot spots. For example, modem devices may enable the computing devices 110, server(s) 120, legal service platform 140, and/or AI-powered solicitation system 150 to be connected to the Internet and/or other network. The modem devices can permit bi-directional communication between the Internet (and/or other network) and the computing devices 110, server(s) 120, legal service platform 140, and/or AI-powered solicitation system 150. In certain embodiments, one or more router devices and/or access points may enable the computing devices 110, server(s) 120, blockchain network devices, legal service platform 140, and/or AI-powered solicitation system 150 to be connected to a LAN and/or other networks. In certain embodiments, one or more mobile hot spots may be configured to establish a LAN (e.g., a Wi-Fi network) that is linked to another network (e.g., a cellular network). The mobile hotspot may enable the computing devices 110, server(s) 120, legal service platform 140, and/or AI-powered solicitation system 150 to access the Internet and/or other networks.

In certain embodiments, the computing devices 110 may represent desktop computers, laptop computers, mobile devices (e.g., smart phones, personal digital assistants, tablet devices, vehicular computing devices, wearable devices, or any other device that is mobile in nature), gaming consoles and/or other types of devices. The one or more servers 120 may generally represent any type of computing device, including any of the computing devices 110 mentioned above. The one or more servers 120 also can comprise one or more mainframe computing devices, one or more virtual servers, one or more application servers, and/or one or more cloud-based servers. In some embodiments, the one or more servers 120 can be configured to execute web servers and can communicate with the computing devices 110 and/or other devices over the network 115 (e.g., over the Internet).

As mentioned above, some or all of the computing devices 110 may represent mobile electronic devices in certain embodiments. Generally speaking, the mobile electronic devices can include any type of electronic device that is portable and/or transportable in nature. In some cases, a mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a cellular telephone (e.g., a smartphone), a personal digital assistant, a handheld digital computer device (e.g., a tablet personal computer device), a digital media player, a wearable device, and/or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For example, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, and/or similar products offered by Apple Inc. of Cupertino, California, United States of America; (ii) a Blackberry® or similar product by Research in Motion (RIM) of Waterloo, Ontario, Canada; (iii) a Lumia® or similar product by the Nokia Corporation of Keilaniemi, Espoo, Finland, and/or (iv) a Galaxy® or similar product by the Samsung Group of Samsung Town, Seoul, South Korea. Further, in the same or different embodiments, a mobile electronic device can comprise an electronic device configured to implement one or more of (i) the iOS® or iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android® operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

The mobile electronic devices can additionally, or alternatively, include wearable devices (e.g., wearable user computer devices) as mentioned above. Generally speaking, wearable devices can generally include any type of electronic device that is capable of being mounted to, worn by, and/or fixed to an individual. For example, in some cases, the wearable devices sometimes can be worn under or over clothing, and/or integrated with the clothing and/or other accessories (e.g., hats, eyeglasses, wristbands, watches, shoes, gloves, etc.). In some cases, wearable devices can be directly mounted or attached to individuals (e.g., the individuals' head, wrist, arms, legs, or neck regions). The wearable devices can comprise a head-mountable wearable user computer device (e.g., one or more head-mountable displays, one or more eyeglasses, one or more contact lenses, one or more retinal displays, etc.) and/or a limb-mountable wearable user computer device (e.g., a smartwatch). In some configurations, the wearable devices can be configured to present audio and/or visual data (e.g., text, images, videos, audio, music, etc.) and/or to receive inputs from individuals (e.g., via one or more input devices such as touchscreens, switches, buttons, etc.). The mobile electronic devices can include additional types of devices other than those explicitly mentioned herein.

In certain embodiments, the legal service platform 140 and/or AI-powered solicitation system 150 can be stored on, and executed by, the one or more servers 120. Additionally, or alternatively, the legal service platform 140 and/or AI-powered solicitation system 150 can be stored on, and executed by, the one or more computing devices 110. Thus, in some embodiments, the legal service platform 140 and/or AI-powered solicitation system 150 can be stored as one or more server applications running on one or more servers 120 and, in other embodiments, can be stored as a local application running on a computing device 110, or integrated with a local application stored on a computing device 110.

Additionally, in some embodiments, the legal service platform 140 and/or AI-powered solicitation system 150 can be implemented as a combination of a front-end application (e.g., which includes a mobile app, native application, and/or web browser stored on a computing device 110) and a back-end application (e.g., which is stored on one or more servers 120). All functionalities of the legal service platform 140 and/or AI-powered solicitation system 150 described herein can be executed by the front-end application, the back-end application, or a combination of both.

In some exemplary configurations, end-users 105 may utilize the computing devices 110 to access the legal service platform 140 over the communication network 115, and the legal service platform 140 may enable the end-users 105 to conduct various types of legal transactions via the platform. Additionally, as described throughout this disclosure, the AI-powered solicitation system 150 of the legal service platform 140 may enable the end-users 105 to execute electronic proposal solicitation processes 151 for soliciting proposals associated with the legal services or transactions.

In some exemplary use cases described herein, a first subset of end-users 105 may correspond to requesting end-users seeking to obtain services and/or seeking to solicit proposals for services, and a second subset of end-users 105 may correspond to service provider end-users that offer services and/or respond to proposals solicited by the requesting end-users.

In some exemplary use cases described herein, the first subset of end-users 105 may correspond to client end-users seeking to obtain legal services and the second subset of end-users 105 may correspond to legal end-users (e.g., such as attorneys, lawyers, legal professionals, paralegals, law firms, etc.) that offer legal services.

The legal service platform 140 may enable both the first subset and second subset of end-users to establish profiles on the platform 140, and may provide various functionalities to each user type via the platform 140. For example, the legal service platform 140 can provide client end-users with various functionalities including, inter alia, functionalities that enable the users to search for legal end-users registered with the platform, publish job postings, create or publish request specifications 153 (e.g., corresponding to RFPs, RFQs, RFIs, job openings, etc.), select or hire legal professional end-users to conduct legal transactions, establish smart contracts with legal professional end-users in connection with the legal transactions, monitor statuses of established smart contracts, etc. Along similar lines, the legal service platform 140 can provide legal end-users with various functionalities including, inter alia, functionalities that enable searching of client end-user profiles, accessing or reviewing job postings, accessing and responding to request specifications 153 submitted by client end-users, establishing smart contracts with client end-users in connection with the legal transactions, monitoring statuses of established smart contracts, etc.

In certain embodiments, client end-users (or other end-users) may utilize an AI-powered solicitation system 150 to solicit, procure, or obtain proposals for various types of services or transactions, including legal services or legal transactions. The AI-powered solicitation system 150 can include, or communicate with, an artificial intelligence (AI) architecture 160 to automate or streamline various aspects of electronic proposal solicitation processes 151 using deep learning technologies, large language model (LLM) technologies, and/or natural language processing (NLP) technologies. In some examples, an electronic proposal solicitation process 151 executed by the AI-powered solicitation system 150 applies an ordered or sequenced process flow that leverages the AI architecture 160 in various stages of the proposal solicitation process, including a first stage which involves the generation of request specifications 153, a second stage which identifies, matches, and/or ranks suitable candidates for receiving the request specifications 153, a third stage which involves the generation of response proposals 157 for the selected candidates, and/or a fourth stage which involves an evaluation of the response proposals 157 received from the selected candidates.

The request specifications 153 described herein may generally correspond to structured or semi-structured documents or requests that define the criteria, requirements, and/or objectives for soliciting proposals, quotations, or information from service providers, such as legal professionals or law firms. These request specifications 153 can be utilized to solicit response proposals 157 for various objectives or purposes, including those which involve requests for proposals (RFPs), requests for quotations (RFQs), requests for information (RFIs), and/or role placement requests. For example, a request specification 153 corresponding to an RFP may outline the scope of legal services being sought, technical and functional requirements, budget constraints, and evaluation criteria, while a request specification 153 corresponding to an RFQ may focus on pricing details for specific services. Likewise, in other examples, a request specification 153 corresponding to an RFI may be used to gather preliminary information to inform future procurement decisions or assess available capabilities or solutions, while a request specification 153 corresponding to a role placement request may define the qualifications and attributes sought for a particular position or job opening. The request specifications 153 can serve as a foundational framework for facilitating efficient communication between the requesting entity and potential respondents.

The response proposals 157 may generally correspond to replies submitted by service providers, such as legal professionals or law firms, in response to request specifications 153. These proposals can be tailored to address the criteria, requirements, and/or objectives outlined in the corresponding request specifications, such as the RFPs, RFQs, RFIs, or role placement requests. Ideally, each response proposal 157 may include detailed information that aligns with the specification parameters included in a corresponding request specification, such that the content addresses descriptions of relevant experience, proposed solutions or plans of action, proposed pricing structures, and/or other pertinent details. For example, a response proposal 157 to an RFP may include a comprehensive plan for delivering legal services, while a response proposal 157 to an RFQ may include a detailed breakdown or estimate of costs and proposed pricing structures. Likewise, a response proposal 157 to an RFI may include a detailed summary of potential technical options, legal options, or other solutions associated with the requested information, while a response proposal 157 to a role placement request may include a detailed breakdown of a candidate's qualifications and suitability for the position. The response proposals 157 enable the requesting entity to evaluate and select the most suitable service provider or candidate for a project or service that is outlined in a request specification 153.

To initiate an electronic proposal solicitation process 151, an end-user 105 may submit a request to establish a new procurement project 155 via the legal service platform 140. In response to receiving the request, the platform 140 may create a new instance of a procurement project 155 and/or may create a new data structure for storing data collected via an electronic proposal solicitation process 151 that is executed with the assistance of the AI-powered solicitation system 150 to solicit response proposals 147 from various candidates. Any or all data collected via the electronic proposal solicitation process 151 may be stored and associated with the procurement project 155 initiated on the platform.

The AI-powered solicitation system 150 can be utilized to enhance the electronic proposal solicitation process 151 in numerous ways.

Initially, a specification assembly engine 152 of the AI-powered solicitation system 150 can utilize one or more language models 164 to rapidly generate or synthesize the request specifications 153 that align with best practices while considering the unique objectives of each end-user 105.

Additionally, a matching engine 154 of the AI-powered solicitation system 150 can utilize one or more language models 164 to identify, match, and/or rank service providers (e.g., legal end-users) to receive the request specifications 153. For example, the one or more language models 164 can be applied to evaluate a large group of candidate service providers in order to select a subset that is determined to be the most qualified or best suited to receive a given request specification 153. This selection process can involve the matching candidate service provider criteria (e.g., such as qualifications, geographic locations, technology integrations, etc.) with the request specification criteria, while performing a holistic analysis that considers the content of the request specification 153, the qualifications of the service providers, and any unique objectives of the requesting user.

Further, on the response side of the electronic proposal solicitation process 151, a proposal synthesis engine 165 can utilize the one or more language models 164 to rapidly generate or synthesize a separate response proposal 157 for each of the candidate service providers that are selected to receive the request specification 153. Amongst other things, the proposal synthesis engine 165 may extract or identify criteria to be included in the response proposals 157 based on an analysis of a corresponding request specification 153, and may synthesize customized content for each response proposal 157 that tailors and/or emphasizes contextually relevant attributes (e.g., relevant experience, qualifications, license compliance, technological capabilities, etc.) for each candidate service provider.

Additionally, in generating the response proposals 157, a remuneration modeling engine 158 can utilize the one or more language models 164 and/or one or more machine-learning models associated with the AI architecture 160 to predict the time or costs associated with a project, estimate resource requirements, and/or generate tailored pricing structures, such as fixed fees, capped fees, alternative fee arrangements (AFAs), contingency fees, or subscription-based models. In some examples, the remuneration modeling engine 158 can be trained on a dataset that comprises historical billing data, market trends, case complexity metrics, or other relevant data to provide optimized, transparent, and competitive pricing strategies that align with the scope of services outlined in the request specifications 153.

In some embodiments, the AI-powered solicitation system 150 may further include a proposal evaluation engine 159 that utilizes the one or more language models 164 to evaluate or assess the response proposals 157 received from multiple service providers. In some examples, the proposal evaluation engine 159 may cause the one or more language models 164 to generate updated rankings for the candidate service providers which consider the content of the response proposals 157, generate final recommendations with regard to selecting service providers after further context is added by analyzing the response proposals 157, and/or generate a report that summarizes the response proposal 157.

Further details on these and other functions performed by the AI-powered solicitation system 150 are described throughout this disclosure.

The type and configuration of the language model(s) 164 described herein can vary. Various types of language models 164 can be utilized by the AI-powered solicitation system 150 and/or autonomous agents 180 described herein. In some embodiments, the language model 164 can include a generative pre-trained transformer (GPT) model (e.g., a GPT-1, GPT-2, GPT-3, GPT-4, or subsequently developed GPT model). Additionally, or alternatively, the language model 164 can include a BERT (Bidirectional Encoder Representations from Transformers) model, an XLNet (Extra-Long Transformer Network) model, a ROBERTa (Robustly Optimized BERT pre-training approach) model, a DeBERTa (Decoding-enhanced BERT with disentangled attention) model, a CTRL (Conditional Transformer Language Model) model, and/or a T5 (Text-to-Text Transfer Transformer) model. These or other types of NLP or AI language models can be used to implement the language model 164.

For simplicity purposes, certain portions of this disclosure may describe the language model 164 as a single learning model. However, it should be understood that the language model 164 can include a plurality of separate learning models, each of which is trained to perform certain tasks or functions and these models can be combined to in various ways to achieve the functions described herein. Thus, any portion of this disclosure that describes communications with a single language model can be interpreted as communicating with one or more language models.

In some exemplary configurations, the language model 164 can include a transformer neural network architecture that includes a self-attention mechanism, which allows the model to weigh the importance of different parts of an input when generating its output or response. The self-attention mechanism allows the model to selectively focus on different parts of the input when generating its output or response, rather than relying on a fixed context window like other language models. Additionally, the transformer neural network architecture can include a series of layers, each of which applies self-attention and other types of neural network operations on a given input that is received. In some examples, the layers can be arranged in a stacked configuration, such that the output of one layer is fed as input to the next layer, thereby allowing the model to gradually refine its representation of the input as it is processed through the layers.

Various types of training procedures can be utilized to train the language model 164. In some cases, one or more supervised or semi-supervised training procedures can be utilized to train the language model 164. Additionally, or alternatively, one or more unsupervised training procedures can be utilized to train the language model 164.

In some embodiments, the language model 164 can be trained via a self-supervised training procedure that includes both an unsupervised training phase and a supervised training phase. The unsupervised training phase can include a pre-training step in which the language model 164 is trained on a large corpus of text to learn patterns and relationships between words, phrases, sentences, and/or other human language elements. The supervised training phase can be used for fine-tuning and can train the language model 164 using one or more labeled datasets to facilitate learning of specific natural language processing (NLP) tasks, such as language translation, language generation, question answering, text classification, text summarization, etc.

Many additional types of training procedures can be utilized to train the language model(s) 164 described herein.

For simplicity purposes, certain portions of this disclosure also may describe the legal service platform 140 as hosting the AI architecture 160 or the corresponding learning models. However, it should be understood that the AI architecture 160, or one or more models associated with AI architecture 160, can be hosted on a separate platform that is accessed by the legal service platform 140, and the legal service platform 140 can communicate with the separate hosting platform (using an application programming interface (API) and/or other communication means to perform the functionalities described herein. Thus, any portion of this disclosure that describes accessing or utilizing the AI architecture 160, language model 164, machine-learning model, and/or other learning model described herein can be interpreted as accessing models hosted on the legal service platform 140, accessing models stored on a separate platform, or a combination thereof.

After a requesting end-user receives response proposals 157 in connection with a procurement project 155 established on the platform, the end-user may access one or more front-end interfaces 145 to review and select one or more of the candidate service providers for the procurement project 155. In some embodiments, the proposal evaluation engine 159 may assist with the selection of the one or more candidate service providers by applying one or more language models 164 to analyze response proposals 157 received from the candidate service providers and to rank or re-rank the candidate service providers based, at least in part, on the content of the response proposals 157. In some examples, the proposal evaluation engine 159 may output an analysis of the response proposals 157 and/or a ranked listing of the candidate service providers, along with recommendations for selecting one or more of the candidate service providers.

In certain embodiments, the AI-powered solicitation system 150 may utilize one or more autonomous agents 180 that are designed to access, gather, process, synthesize, and/or retrieve relevant data to enhance the functionalities of the specification assembly engine 152, matching engine 154, proposal synthesis engine 156, remuneration modeling engine 158, and/or proposal evaluation engine 159.

In certain embodiments, the autonomous agents 180 can be implemented with data acquisition modules that leverage web scraping, API integrations, and/or database queries to autonomously collect data from various sources. In some embodiments, the autonomous agents 180 also may include, or utilize, an NLP system 162 (or one or more language models 164) to analyze, interpret, digest, reformat, and/or reorganize content that is collected. The collected data can then be structured and formatted to be seamlessly integrated into the respective engines. Some or all of the data collected by the autonomous agents 180 may include unstructured data or natural language data and the autonomous agents 180 may utilize the NLP system 162 to transform the collected data into structured data or structured representations.

In certain embodiments, the AI-powered solicitation system 150 and its associated components (including the specification assembly engine 152, matching engine 154, proposal synthesis engine 156, remuneration modeling engine 158, proposal evaluation engine 159, etc.) can be adapted to generate and/or customize various prompts 168 to elicit the desired outputs from the one or more language models 164. These prompts 168 may be specifically designed to control the language models in generating accurate, contextually relevant, and tailored outputs for various stages of the proposal solicitation processes 151.

For example, the specification assembly engine 152 may generate and transmit one or more prompts 168 to instruct the language models to synthesize a request specification 153 by extracting key parameters or criteria from unstructured client inputs, such as natural language descriptions or uploaded documents, and converting them into structured formats aligned with industry best practices. Similarly, the matching engine 154 may employ one or more prompts 168 to control the manner in which the language model 164 analyzes the criteria outlined in a request specification 153, correlates the specification criteria with candidate attributes (e.g., by evaluating their profiles, qualifications, and experience, etc.) and/or to ranks the identified candidates. In further examples, the proposal synthesis engine 156 may generate and transmit one or more prompts 168 to elicit content generated by one or more language models in connection with pre-filling response proposals 157, and customizing the prompts 168 to help ensure the content of the response proposals are aligned with the request specification parameters and tailored to highlight relevant attributes of the corresponding service providers. Additionally, the remuneration modeling engine 158 may utilize prompts to determine appropriate alternative fee arrangements (AFAs) and/or to predict costs or time requirements for a project based on historical billing data and market trends.

Prompts 168 can be dynamically adjusted based on the specific use case or context, such as tailoring the language model to focus on particular practice areas, geographic locations, and/or client objectives. For instance, a prompt 168 for an RFP related to intellectual property law may emphasize qualifications in patent prosecution and litigation, while a prompt for a role placement request may prioritize attributes such as years of industry experience, educational background, and diversity metrics. By leveraging these customized prompts 168, the AI-powered solicitation system 150 enables the language models 164 to produce outputs that are contextually relevant and tailored to the unique criteria associated with both the client end-users and legal end-users.

In certain embodiments, after a service provider is selected to provide services in connection with a request specification 153, the parties involved with the request specification 153 (e.g., the client end-user or service provider end-user that created the request specification 153 and each service provider or legal end-user selected to provide services) may enter into a smart contract via the legal service platform 140. This smart contract may be linked to, or managed on, one or more blockchain networks 130 and may be used to facilitate the automated execution of contractual terms in a manner that ensures transparency and provides an immutable record of the legal transaction.

In some examples described throughout this disclosure, the legal service platform 140 can be integrated into a networking site or platform that connects client end-users and legal end-users. For example, the legal service platform 140 may provide a networking environment that enables client end-users to create and publish request specifications 153 on the platform 140, and which permits legal end-users to submit response proposals 157 corresponding to the request specifications 153. The AI-powered solicitation system 150 can automate or streamline the procurement projects 155 in this network environment that connects client end-users with legal end-users.

However, the technologies described herein have broader applicability and can generally be applied to facilitate or manage procurement projects 155 in any context. For instance, in other exemplary embodiments, the technologies described herein can be integrated into an electronic system or IT infrastructure utilized by law firms, corporations, accounting firms, real estate title companies, consultant companies, and/or other types of businesses to create request specifications 153 and solicit response proposals 157. The technologies can be applied in other contexts and environments as well.

In some examples described herein, the one or more computing devices 110 can execute a mobile app or web browser that enables end-users 105 to access the legal service platform 140 over the network 115 (e.g., over the Internet). The legal service platform 140 can provide a framework that connects and facilitates communications among end-users 105 and enables the end-users 105 to solicit response proposals 157 and conduct legal transactions via the platform. The legal service platform 140 can leverage the AI-powered solicitation system 150 to solicit response proposals 157 in an automated or semi-automated fashion, enabling both client end-users and legal end-users to access various AI functionalities to streamline the proposal solicitation process.

The legal service platform 140 can enable end-users 105 to create request specifications 153 to solicit response proposals 157 for various types of legal services or transactions. In some examples, a request specification 153 can solicit response proposals 157 for legal services or transactions that involve representing clients in connection with court, arbitration, and/or mediation proceedings, preparing and executing various types of legal documents, conducting attorney consultations, and/or many other types of issues that involve legal expertise.

Additionally, the request specifications 153 created and/or published via the legal service platform 140 can generally correspond to any legal practice area, including, but not limited to, practice areas encompassing contract law, real estate law, litigation, intellectual property law (including patent, trademark, copyright, and/or trade secret laws), family law, criminal law, corporate law, tax law, environmental law, labor and employment law, immigration law, bankruptcy law, health law, entertainment law, and/or international law.

In one example, a request specification 153 can solicit response proposals 157 for legal services that involve drafting, reviewing, editing, and/or negotiating contracts. In another example, a request specification 153 can solicit response proposals 157 for legal services that involve real estate or property purchases, sales, and/or leases. In another example, a request specification 153 can solicit response proposals 157 for legal services that involve preparing, filing, and/or prosecuting patent applications, trademark applications, and/or copyright applications. In another example, a request specification 153 can solicit response proposals 157 for legal services that involve representing clients in civil litigations. In another example, a request specification 153 can solicit response proposals 157 for legal services that involve representing or defending clients in criminal proceedings. In another example, a request specification 153 can solicit response proposals 157 for legal services that involve preparing legal opinions.

In further examples, a request specification 153 can be utilized to solicit proposals for title services. For example, a request specification 153 can solicit response proposals 157 from legal end-users (e.g., title companies or individuals that perform title services) to secure title services that involve conducting a title search, securing title insurance, placing amounts in escrow, obtaining closing services, obtaining deed recording services, and/or the like.

In another example, a request specification 153 can be created that defines the requirements or criteria for a job opening, role, or position, and the request specification 153 can be utilized to solicit response proposals 157 from candidates applying for the job opening, role, or position.

In some embodiments, the legal service platform 140 provides one or more front-end interfaces 145, which enable the end-users 105 to access and utilize the various functionalities of the legal service platform 140 described throughout this disclosure. The front-end interfaces 145 may comprise graphical user interfaces (GUIs) and/or other types of interfaces that can be accessed by the computing devices 110 operated by end-users 105. In some examples, the front-end interfaces 145 may be presented via mobile apps, local applications, and/or web browser applications installed on the computing devices 110. Amongst other things, the front-end interfaces 145 may enable the end-users 105 to log in and access user accounts maintained by the legal service platform 140.

In facilitating the procurement projects 155 and/or legal transactions via the legal service platform 140, a decentralized network integration system 170 of the legal service platform 140 can communicate with one or more blockchain networks 130 to record data corresponding to the procurement projects 155, legal transactions, and/or smart contracts established by parties. Additionally, the decentralized network integration system 170 can communicate with one or more distributed storage networks 135 to store documentation and/or other data related to the procurement projects 155, legal transactions, and/or smart contracts established by parties. The decentralized network integration system 170 incorporates software code or programming logic that allows the legal service platform 140 to utilize blockchain technologies and/or distributed storage technologies for various purposes in facilitating the procurement projects 155 and legal transactions.

In administering the procurement projects 155 and/or legal transactions, the legal service platform 140 can leverage various functionalities enabled by one or more blockchain networks 130. In some examples, the legal service platform 140 may communicate with one or more blockchain networks 130 to authenticate end-users 105 who access the platform, record data associated with the procurement projects 155 on a blockchain ledger, implement smart contracts between a party that initiated a procurement project 155 and one or more candidate service providers that were selected for the procurement project 155, facilitate the exchange of tokens and/or cryptocurrencies to render payment for services, and/or other functionalities. Additionally, the legal service platform 140 can leverage functionalities of the one or more distributed storage networks 135 to securely store documentation corresponding to the procurement projects 155, smart contracts, and/or legal transactions on the legal service platform 140.

In some embodiments, the legal service platform 140 functions as an intermediary or middle layer positioned between end-users 105 and the blockchain networks 130 (and positioned between the end-users 105 and the decentralized storage networks 135). This network layout or configuration allows the legal service platform 140 to seamlessly leverage blockchain and/or distributed storage functionalities without burdening end-users 105 with the technical complexities often associated with the usage of blockchain technologies (e.g., such as wallet setup, security key management, network connectivity, etc.) and distributed storage technologies (e.g., P2P networking, encryption protocols, etc.), while providing the end-users 105 benefits such as enhanced data confidentiality in conducting legal transactions, secure authentication of end-users, verifiable and immutable audit trails relating to procurement projects 155 and legal transactions, secure storage of data in distributed environments, automated consensus-based verification, and/or other advantages detailed in this disclosure.

In some examples, the decentralized network integration system 170 can enable the client end-users and legal professional end-users to establish smart contracts to govern their relationship with each other and/or the legal transactions conducted via the legal service platform 140. The smart contracts may correspond to self-executing contracts that are executed on the one or more blockchain networks 130, and which automatically execute certain actions when certain predefined criteria corresponding to the legal transactions are satisfied.

This smart contract-enabled automation can eliminate the need for intermediaries, streamlining the process, efforts, and time for legal transactions. The transparency of smart contracts ensures that all terms and conditions are visible and/or verifiable on the blockchain, fostering trust and reducing disputes between parties. Additionally, the security provided by the immutable nature of blockchain technology minimizes the risk of fraud and manipulation, ensuring that once a contract is deployed, it cannot be altered. This enhances the integrity of legal transactions on the platform. Furthermore, the efficiency gained from eliminating manual processing allows for quicker resolution of legal matters, benefiting both clients and legal professionals by reducing administrative burdens and costs.

In facilitating the legal transactions and/or procurement projects 155 via the legal service platform 140, various types of documentation may be exchanged between client end-users and legal professional end-users via the platform. In some examples, the documentation may include request specifications 153, response proposals 157, and/or communications that occur during electronic proposal solicitation processes 151. The documentation also may include data, information, or documents that are exchanged via the platform after the electronic proposal solicitation processes 151 are concluded, and smart contracts or agreements are established between the request specification creators and the selected service providers. For example, after a request specification creator initially engages the services of a legal end-user, certain types of documentation (e.g., engagement letters, non-disclosure agreements, retainer agreements, RFPs, scope of work summaries, etc.) may be exchanged between the parties for establishing their relationship and/or the scope of work. Throughout the course of their relationship, various types of documentation may also be exchanged (e.g., such as electronic documents or files corresponding to contracts, real estate agreements, legal briefs, court documents, patent applications, trademark applications, invoices, arbitration documents, etc.). The documentation collected by the legal service platform 140 also may reflect communications exchanged between a client end-user and a legal professional end-user (e.g., such as text, audio, and/or video communications exchanged between the parties) via communication functions provided on the legal service platform 140 (e.g., via inbox messages, instant messaging functions, and/or videoconferencing functions provided via the platform 140).

Some or all of the documentation can be stored by the legal service platform 140 (e.g., in one or more databases maintained or accessed by the legal service platform 140). In certain embodiments, the legal service platform 140 may include, utilize, and/or communicate with a distributed storage network 135 to store the transaction documentation. The decentralized network integration system 170 of the legal service platform 140 may store software code or logic for communicating with one or more distributed storage networks 135 in connection with facilitating the distributed storage of the documentation and/or retrieving or accessing transaction documentation previously stored in the distributed storage networks 135.

In certain embodiments, the distributed storage network 135 may be configured to store the documentation across a distributed network of nodes (rather than, or in addition to, storing the data on centralized servers). In accordance with certain decentralized storage protocols, the documentation may be split into smaller, encrypted pieces and distributed across multiple nodes. Additionally, when the documentation is needed or desired, the documentation may be reconstructed (e.g., using cryptographic verification techniques).

The decentralized storage of documentation by the legal service platform 140 offers several notable benefits. By distributing encrypted data across multiple nodes, the system ensures that documentation is not subject to fraud, tampering, or other malicious activities, and it ensures the integrity of the documentation. Additionally, the decentralized storage of documents provides redundancy benefits, as copies of the data can be stored in various locations, preventing data loss. Moreover, this approach can enhance security by spreading encrypted data across multiple sites, making unauthorized access more difficult. Furthermore, the decentralized nature of the storage system provides fault tolerance, eliminating a single point of failure that may be present in traditional cloud storage solutions. These benefits collectively enhance the robustness and security of the legal service platform, ensuring that documentation is securely stored and readily accessible when needed, and ensuring that the documentation is not subject to fraud or tampering.

The system configurations described herein are provided as examples to demonstrate environments in which the embodiments described herein can be deployed. Numerous modifications and variations to the disclosed embodiments are possible, and the techniques described herein can be implemented in many other contexts and environments.

The technologies described herein can be applied in many different contexts or environments other than, or in addition to, those which involve soliciting proposals for legal services, conducting legal transactions, and/or establishing connections between clients and legal professional end-users. In some exemplary use cases, the technologies can be applied to conduct transactions in other contexts and/or for other types of services. In one example, the technologies can be applied to solicit proposals and/or conduct transactions for accounting services. In another example, the technologies can be applied to solicit proposals and/or conduct transactions for software developers, IT specialists, or the like. In one example, the technologies can be applied to solicit proposals and/or conduct transactions for healthcare services. In another example, the technologies can be applied to solicit proposals and/or conduct transactions for real estate services. In another example, the technologies can be applied to enable government contractors to solicit proposals from governmental entities. Thus, any exemplary embodiment mentioned in this disclosure that is described as applying to legal transactions or legal services (or involving client end-users and legal end-users) also can be applied to conduct other types of transactions (and can more broadly apply to end-users seeking services and end-users who provide services).

Additionally, the components illustrated in FIG. 1B can be combined or integrated in various ways to implement the functionalities described herein. For example, while the components may be described as being distinct components in some instances, it should be understood that the functionalities of the components can be combined or integrated in any manner whatsoever, and the labels assigned to these components are merely to facilitate understanding of the techniques and functions described herein.

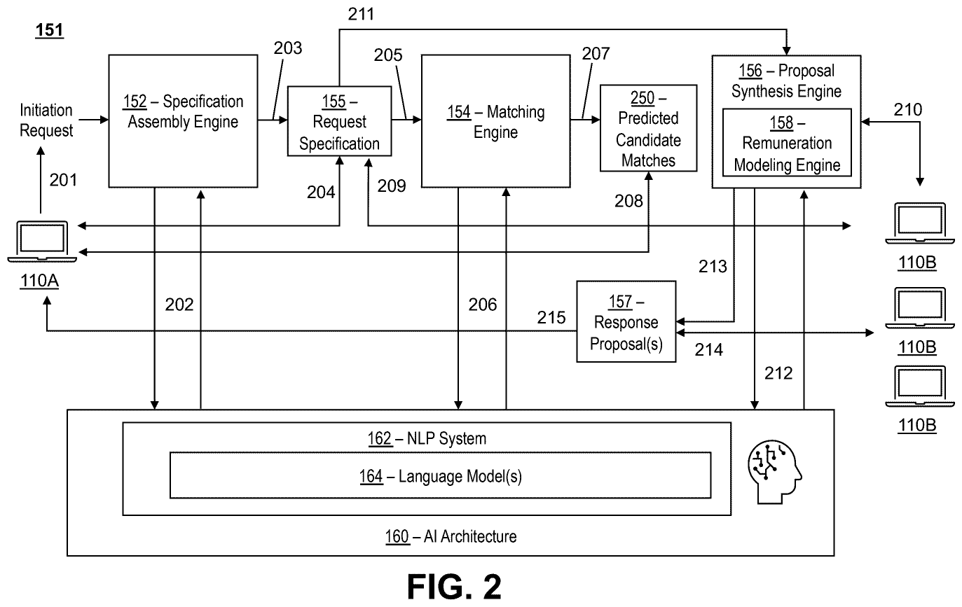

FIG. 2 is a flow diagram illustrating an exemplary proposal solicitation process 151 according to certain embodiments. The electronic proposal solicitation process 151 may be executed, at least in part, by the AI-powered solicitation system 150 described herein.

In step 201, the electronic proposal solicitation process 151 may begin with a requesting end-user using a first computing device 110A to initiate a request for a new procurement project 155. In some examples, the requesting end-user may correspond to a client end-user that is seeking legal services from a legal end-user registered with the legal service platform 140, and the requesting end-user may utilize the electronic proposal solicitation process 151 to gather response proposals 157 for an RFP, RFQ, or RFI corresponding to the specific legal services being sought. In other examples, the requesting end-user may correspond to a client end-user or legal end-user that is seeking to hire a service provider, such as an attorney or legal end-user, and the requesting end-user may initiate a role placement request to procure a new employee or contractor.

The specification assembly engine 152 receives the request and initiates a process for generating a request specification 153 corresponding to the request. In some examples, the specification assembly engine 152 may receive or collect contextual data that is utilized to synthesize the request specification 153, such as stored profile information for the requesting end-user, data that is collected by one or more autonomous agents 180 from one or more web resources, and/or project description data that is provided by the requesting end-user (e.g., which may include a natural language description of the objectives associated with the request specification 153 and/or any documentation related to the request specification 153).

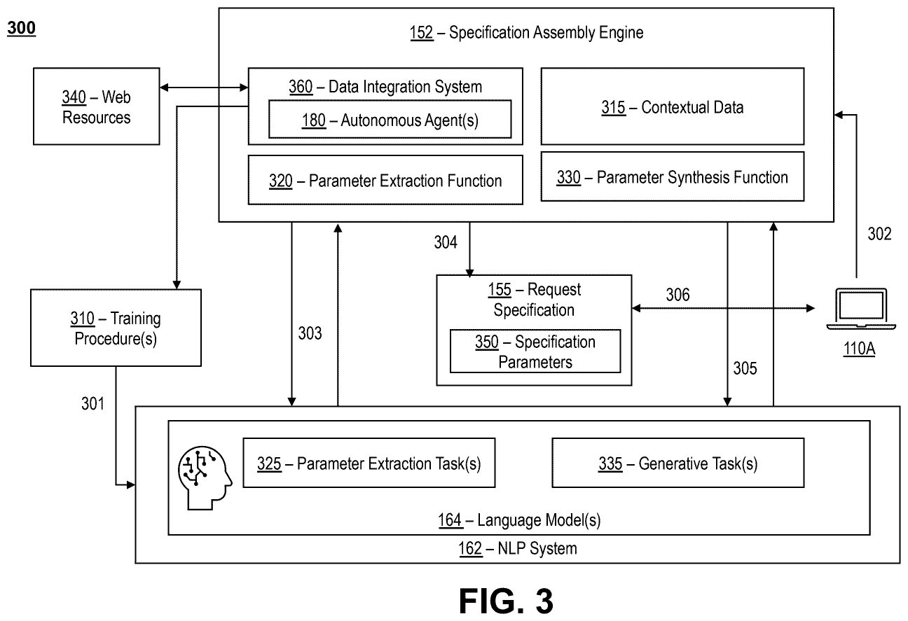

In step 202, the specification assembly engine 152 initiates a communication exchange with an NLP system 162 comprising at least one language model 164 to generate the request specification 153. In some examples, the specification assembly engine 152 may generate and/or customize one or more prompts 168 to assemble or derive the request specification 153. The prompts 168 may be customized or tailored based on the contextual data. In response to receiving the one or more prompts 168, the one or more language models 164 may utilize the contextual data to generate or synthesize the request specification 153. Additional details on exemplary techniques that can be applied by the specification assembly engine 152 to generate the request specification 153 are described in other portions of this disclosure, including the description of FIG. 3.

In step 203, the specification assembly engine 152 outputs the request specification 153.

In step 204, the requesting end-user may utilize the first computing device 110A to access, review, modify, and/or revise the request specification 153 generated by the specification assembly engine 152.

In step 205, the request specification 153 is received by the matching engine 154 after it is finalized or approved by the requesting end-user. The matching engine 154 initiates a process that attempts to identify or predict the best service providers, such as legal end-users, for fulfilling the request specification 153.

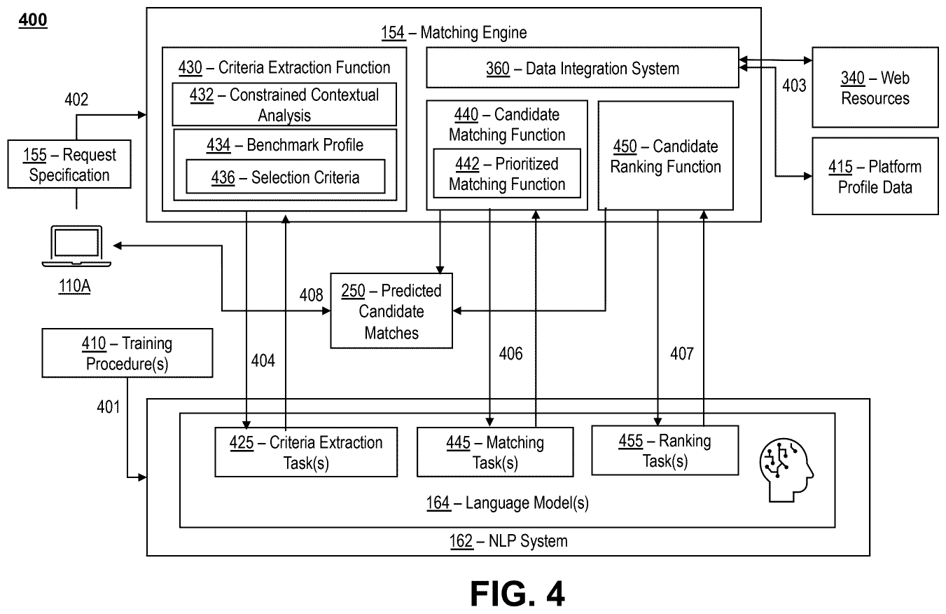

In step 206, the matching engine 154 initiates a communication exchange with the NLP system 162 comprising at least one language model 164 to identify one or more suitable service providers for the request specification 153 and/or rank the identified service providers based on their predicted alignment with the request specification objectives. In some examples, the matching engine 154 may generate and/or customize one or more prompts 168 to select and/or rank the service providers for the request specification 153. The matching engine 154 and/or the language models 164 may receive or access various data associated with each of the service providers registered with the legal service platform 140, including data that is associated with the stored service provider profiles and/or data that is collected by the autonomous agents 180. The one or more language models 164 utilize this data to analyze the pool of candidate service providers and execute a matching process that selects or identifies a subset of service providers that are predicted to be the best matches for fulfilling the request specification 153, and to determine a ranking or ordering for the selected subset of service providers based on their predict alignment with the request specification 153. Additional details on exemplary techniques that can be applied by the matching engine 154 to match or rank service providers are described in other portions of this disclosure, including the description of FIG. 4.

In step 207, the matching engine 154 outputs predicted candidate matches 250, which can include a listing of candidate service providers predicted to be best suited for fulfilling the request specification 153. In some embodiments, the listing of predicted candidate matches 250 may be ranked or ordered based on their predicted suitability and/or predicted alignment with the objectives of the requesting end-user.

In step 208, the requesting end-user may utilize the first computing device 110A to access, review, modify, and/or revise the predicted candidate matches 250 generated by the matching engine 154. In some examples, the requesting end-user may approve the predicted candidate matches 250, may supplement the predicted candidate matches 250 with one or more additional service providers, and/or may remove one or more service providers. In some cases, the predicted candidate matches 250 presented to the requesting end-user also may include details corresponding to each of the corresponding service providers (e.g., relevant experience, geographic location, etc.) and/or may highlight aspects of the service providers which align with the specification criteria or parameters set forth in the request specification 153.

In step 209, the request specification 153 is transmitted or provided to each of the service providers approved by the requesting end-user, and the service providers utilize a second set of computing devices 110B to access and review the request specification 153. In some examples, the service providers may correspond to legal end-users, such as attorneys or other legal professionals.

In step 210, one or more of the service providers that received the request specification 153 may utilize or access a proposal synthesis engine 156, which can be configured to automate or streamline the generation of response proposals 157 for each of the service providers.

In step 211, the proposal synthesis engine 156 may access or receive the request specification 153. In some embodiments, for each service provider that utilizes the functionality of the proposal synthesis engine 156, the proposal synthesis engine 156 also may receive or access various data about the service provider, including data that is associated with the stored service provider's profile, data that is collected by the autonomous agents 180, and/or additional contextual data that is input by the service provider in response to reviewing the request specification 153 (e.g., such as data indicating specific prior experience with handling projects similar to the request specification 153).

In step 212, the proposal synthesis engine 156 initiates a communication exchange with the NLP system 162 comprising at least one language model 164 to generate a response proposal 157 for each service provider that utilizes or accesses the proposal synthesis engine 156. In some examples, the proposal synthesis engine 156 may generate and/or customize one or more prompts 168 to assemble or derive each of the response proposals 157. The prompts 168 may be customized or tailored based on the service provider profile, data that is collected by one or more autonomous agents 180, and/or any additional contextual data provided by the service provider. For each service provider, the one or more language models 164 utilize their corresponding data to generate or synthesize a response proposal 157 that is customized according to the unique attributes of the service provider (e.g., incorporating content that is specific to their experience, practice area specialties, handling of similar projects, etc.).

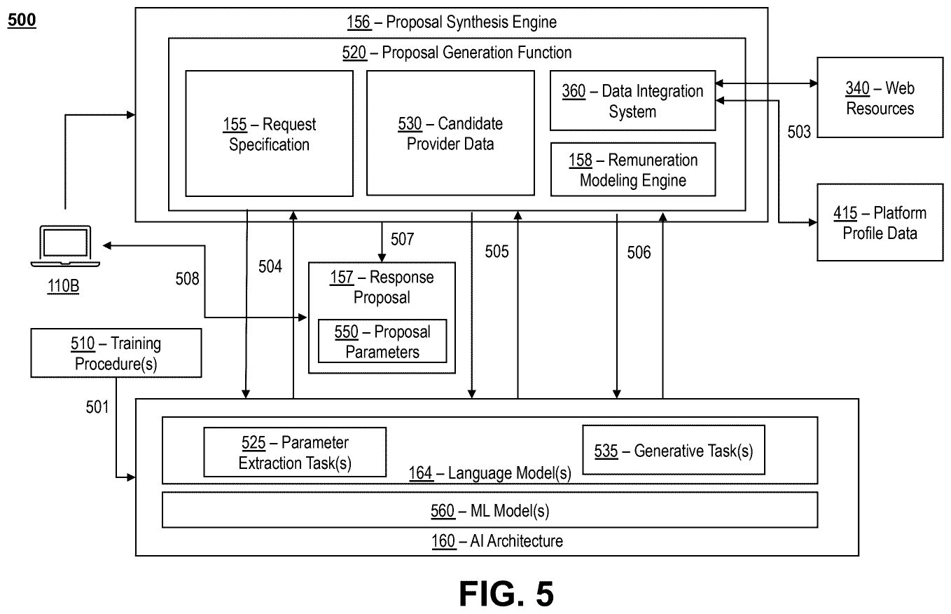

In certain embodiments, the proposal synthesis engine 156 may include a remuneration modeling engine 158 that is utilized to generate certain portions of the response proposals 157 that pertain to proposed pricing, cost, or fee arrangements. In some examples, the remuneration modeling engine 158 can generate and transmit one or more custom prompts 168 to the one or more language models 164 for obtaining one or more proposed fee arrangements (e.g., which may include both standard fee structures and/or AFAs), and the one or more proposed fee arrangements may be integrated into each of the response proposals 157. Additional details on exemplary techniques that can be applied by the proposal synthesis engine 156 and remuneration modeling engine 158 to generate the response proposals 157 are described in other portions of this disclosure, including the description of FIG. 5.

In step 213, the proposal synthesis engine 156 outputs a response proposal 157 for each service provider.

In step 214, each response proposal 157 generated by the proposal synthesis engine 156 is provided to a corresponding service provider, which may utilize their respective computing devices 110B to access, review, modify, and/or revise the response proposal 157.

In step 215, each service provider may transmit their corresponding response proposal 157 to the requesting end-user after finalizing or approving their response proposal 157.

In certain embodiments, the electronic proposal solicitation process 151 also may involve additional steps of reranking and/or reevaluating the service providers after the response proposals 157 are received. For example, after the requesting end-user has received all of the response proposals 157, the proposal evaluation engine 159 can re-rank, reevaluate, and/or provide final recommendations on selecting a service provider for the request specification 153, and a proposal evaluation engine 159 may initiate a communication exchange that prompts the one or more language models 164 to evaluate or assess the response proposals 157 received from the service providers.

The electronic proposal solicitation process 151 illustrated in FIG. 2 is merely exemplary and is not limited to the embodiments presented herein. The electronic proposal solicitation process 151 can be employed in many different embodiments or examples not specifically depicted or described herein. In some embodiments, the steps of the electronic proposal solicitation process 151 can be performed in the order presented. In other embodiments, the steps of the electronic proposal solicitation process 151 can be performed in any suitable order. In some embodiments, additional steps can be added to the electronic proposal solicitation process 151. In still other embodiments, one or more of the steps of the electronic proposal solicitation process 151 can be combined or skipped.

FIG. 3 is a flow diagram illustrating an exemplary specification synthesis process 300 according to certain embodiments. The specification synthesis process 300 may be executed, at least in part, by the specification assembly engine 152 and/or AI-powered solicitation system 150 described herein. While the discussion below primarily describes an exemplary technique for assembling or synthesizing a request specification 153 corresponding to an RFP for legal services, it should be understood that the same or similar technique can be applied to assemble or synthesize other types of request specifications 153 (e.g., such as those that involve RFQs, RFIs, role placement requests, etc.) and/or to assemble or synthesize request specifications 153 other types of services (e.g., accounting services, IT services, etc.).

At step 301, one or more training procedures 310 are applied to the NLP system 162 and/or a language model 164 associated with the NLP system 162. In certain embodiments, the one or more training procedures 310 may include a supervised, unsupervised, and/or semi-supervised training procedure that trains or fine-tunes the language model 164 to perform the parameter extraction tasks 325, generative tasks 335, and/or other NLP tasks described in this disclosure.

In some embodiments, a training procedure 310 may be applied that utilizes domain-specific data corresponding to request specifications 153 (e.g., RFPs, RFQs, RFIs, role placement requests, etc.) and/or solicitation processes. In some examples, the domain-specific data may comprise a dataset of request specifications 153 and/or response proposals 157 and, in some cases, historical request specifications and/or response proposals that were utilized in previous proposal solicitation processes (e.g., conducted on the legal service platform 140 and/or outside of the legal service platform 140). In some embodiments, the one or more training procedures 310 applied to train or fine-tune the language model 164 may comprise a supervised training procedure 310 that utilizes ground-truth labels or annotations inserted into the request specifications in the dataset, such as ground-truth labels or annotations identifying a legal practice area associated with each request specification and/or ground-truth labels or annotations identifying specification parameters 350 included in the request specifications (e.g., including labels that identify scope of work parameters, timeline parameters, remuneration structure parameters, etc.). This labeled training dataset may be fed into the language model 164 during a training stage to hone the ability of the model 164 to perform the parameter extraction tasks 325, generative tasks 335, and/or other NLP tasks described herein.

In certain embodiments, a data integration system 360 and/or one or more autonomous agents 180 can be utilized to collect, process, and/or synthesize the training data, or at least a portion of the training data, that is utilized to train or fine-tune the language model 164. In some embodiments, an autonomous agent 180 can be configured with various types of data collection, gathering, or extraction functionalities that are utilized to collect domain-specific data related to request specifications 153 from one or more web resources 340 (e.g., which may include third-party databases, websites, and/or other web sources). In some examples, the autonomous agent 180 may be configured with web scraping functions that operate to collect, extract, and/or aggregate relevant data from the web resources 340, such as legal directories, firm websites, public databases, and/or the like, to provide comprehensive and up-to-date information for use in generating request specifications 153. Additionally, or alternatively, the autonomous agent 180 may be configured to communicate with one or more APIs associated with certain web resources 340 to collect, extract, and/or aggregate relevant data.

In some embodiments, the autonomous agent 180 also can be configured with LLM and/or NLP functionalities to synthesize, normalize, digest, summarize, and/or otherwise process the data collected from the web resources 340. For example, the autonomous agent 180 may include or communicate with one or more language models 164 to analyze, interpret, and/or synthesize the collected data, transforming unstructured or semi-structured information into structured formats that can be seamlessly integrated into the operations of the specification assembly engine 152 and/or training procedure 310 applied to the language model 164. Any data collected and/or processed by the autonomous agents 180 and/or data integration system 360 described in this disclosure can be utilized to train the at least one language model 164.

In certain embodiments, the one or more training procedures 310 (and/or associated training data) can enhance the ability of the language model 164 to understand nuances in the specification parameters 350 for different types of request specifications 153, such as industry-specific parameters, practice area-specific parameters, standard parameters commonly associated with legal request specifications, etc. The one or more training procedures 310 (and/or associated training data) also can enhance the ability of the language model 164 to detect if certain types of specification parameters 350 are missing or omitted from the request specifications 153.

In addition to enhancing the training procedures 310 applied to the language model 164, the data collected by the one or more autonomous agents 180 may be stored and/or accessed by the specification assembly engine 152 for other purposes. In some examples, the specification assembly engine 152 may utilize the data collected and/or processed by an autonomous agent 180 to customize or hone prompts 168 that are transmitted to the language model 164, including the prompts described below.

In step 302, a requesting end-user initiates a request for a new procurement project 155 and the request is received by the specification assembly engine 152. In some examples, the requesting end-user may represent a client end-user that is seeking to solicit proposals for legal services from one or more legal end-users.

In certain embodiments, the specification assembly engine 152 can store and/or associate various types of contextual data 315 with the new procurement project 155 that is created on the legal service platform 140. The contextual data 315 may generally include any information related to the nature of the procurement project 155 and/or the parties involved with the procurement project 155 (e.g., including the requesting end-user and/or business associated with the requesting end-user). The contextual data 315 may be gathered directly from the requesting end-user and/or may be collected by the data integration system 360 using automated techniques.

In some examples, the contextual data 315 may provide an unstructured or natural language description of the services being sought and/or related background information. Additionally, or alternatively, the contextual data 315 may include data or information that is collected via an electronic form and/or extracted from documents that are uploaded by the requesting end-user. For instance, the contextual data 315 may indicate that the requesting end-user is seeking proposals from attorneys or law firms for handling a litigation in which the requesting end-user is involved and/or may indicate that the requesting end-user is seeking proposals from attorneys or law firms for handling a legal transaction, such as a real estate closing. The contextual data 315 may identify one or more practice areas associated with the legal services being sought (e.g., indicating that the end-user is seeking assistance with legal areas such as real estate, intellectual property, employment disputes, merger or acquisition, etc.). In some scenarios, the contextual data 315 also may include documents related to the procurement project 155 (e.g., such as court complaints, contracts, agreements, etc.), which can be processed by the language model 164 to extract relevant details.

Additional contextual data 315 relating to the procurement project 155 may also be extracted from other sources. In one example, the requesting end-user may include a profile associated with the legal service platform 140 and the specification assembly engine 152 may access the profile information to obtain information about the requesting end-user, the company or entity associated with the requesting end-user, the industry associated with the requesting end-user, etc. In another example, additional contextual data 315 may be extracted by an autonomous agent 180 from one or more web resources 340, which may include data pertaining to the requesting end-user (or an affiliated business entity), data pertaining to the industry or sector associated with the requesting end-user, data pertaining to one or more parties that are adverse to the requesting end-user, and/or data that is obtained from public databases (e.g., court filing systems or legal databases) relating to a dispute or litigation associated with the procurement project 155. In another example, additional contextual data 315 may be extracted from historical procurement projects 155 associated with the requesting end-user (or an affiliated entity).

In step 303, a parameter extraction function 320 of the specification assembly engine 152 initiates a communication exchange with the language model 164 to extract or identify specification parameters 350 corresponding to the request specification 153 being assembled or synthesized. In this communication exchange, the parameter extraction function 320 may transmit one or more prompts 168 that are tailored to extract contextually relevant specification parameters 350. The one or more prompts 168 may include some or all of the contextual data 315. In some examples, in response to receiving one or more prompts 168, the language model 164 may execute one or more parameter extraction tasks 325 that identify or extract the corresponding specification parameters 350. The specification parameters 350 may be returned to the specification assembly engine 152 for assembling or synthesizing the request specification 153.

In general, each specification parameter 350 may correspond to a data point, attribute, variable, or field that is included or incorporated into a request specification 153 being assembled or synthesized by the specification assembly engine 152. Each specification parameter 350 may identify a type or category of information that is being solicited from service providers and/or details about the scope of services or parties associated with the request specification 153.

In an example of an RFP for legal services, the request specification 153 may incorporate specification parameters 350 including one or more of the following:
a) a requesting party parameter that specifies information about the client or entity initiating the RFP, such as the organization's name, industry, and relevant background details;
b) a service provider parameter that requests information about each service provider that responds to the request specification 153 (e.g., indicating the firm's location, size, number of attorneys, areas of specialization, and years in operation);
c) an experience parameter that requests information from service providers related to their prior experience with handling similar matters (e.g., including representative cases, outcomes, client testimonials, etc.);
d) a jurisdictional parameter that specifies the geographic regions or legal jurisdictions relevant to the services being requested, such as state, federal, or international jurisdictions;
e) a timeline parameter that outlines the expected duration of the project or milestones and deadlines for deliverables;
f) a remuneration structure parameter that requests information from service providers on proposed billing arrangements, such as hourly rates, flat fees, alternative fee arrangements (AFAs), or contingency fees;
h) a conflict of interest parameter that requires disclosure of any potential conflicts of interest and the service provider's policies for managing such conflicts;
i) a technology and innovation parameter that requests information about the service provider's use of technology, such as document automation tools, e-discovery platforms, or other legal tech solutions;
j) a confidentiality and data security parameter that outlines requirements for safeguarding sensitive information and/or requests details on the service provider's data protection measures; and/or
k) a plan of action parameter that requests information regarding how each service provider intends to handle the legal issue that is the subject of the request specification.

Technical challenges can arise with respect to selecting or identifying the particular specification parameters 350 to be incorporated into a given request specification 153, due to the wide-ranging diversity of specification parameters 350 for heterogeneous request specifications 153. Many different factors can impact the selection of specification parameters 350 for each unique request specification 153. For example, the specification parameters 350 can vary based on the type of request specification 153 (e.g., based on whether the request specification 153 corresponds to an RFP, RFQ, RFI, role placement request, etc.). In another example, the specification parameters 350 can vary based on the legal practice areas that are implicated by the request specification 153 (e.g., the specification parameters 350 pertaining to a request specification 153 for an employment dispute can differ from the specification parameters 350 for a criminal proceeding or corporate merger transaction). In another example, the specification parameters 350 can vary based on the geographic or jurisdictional considerations. For instance, the specification parameters 350 can vary based on the geographic locations where legal services are to be rendered (e.g., such that certain countries or states may implicate additional specification parameters 350 that are not appliable to others), based on a jurisdiction where a legal proceeding is pending or a dispute arises (e.g., such that different specification parameters 350 may be implicated for disputes or proceedings arising under federal law versus state laws), and/or based on licensing or certification requirements that can vary across specific geographic areas or jurisdictional entities. In another example, the specification parameters 350 can vary based on the nature of the legal services being requested (e.g., based on whether the legal services require litigation skills and/or transactional skills).

These technical challenges can further be complicated in scenarios where the requesting end-user introduces specialized or unique requirements for the request specification 153 being constructed. In some examples, a requesting end-user may indicate the requirement that a service provider be located within a certain distance of their office (e.g., within X miles of the company location). In other examples, a requesting end-user may indicate the need for specialized AFAs, such as tiered pricing models, blended hourly rates, or subscription-based fee arrangements. Other unique considerations may include requirements for multilingual capabilities to address international legal matters, or stipulations for collaboration with in-house counsel or third-party vendors. Furthermore, the requesting end-user may specify requirements for certain technological infrastructures, such as system integrations that permit both in-house counsel and the service providers to access data and information.

The techniques described herein can enable the specification assembly engine 152 to overcome the aforementioned technical challenges and/or other related challenges. Amongst other things, the training procedures 310 described herein can enable the at least one language mode 164 to learn the precise specification parameters 350 that should be incorporated into each particular request specification 153, while accounting for nuanced variations across different request specifications types, different legal practice areas, industry-specific requirements, geographic or jurisdictional considerations, varying types of legal issues (e.g., litigation issues versus transactional issues), and/or the unique objectives or constraints of the requesting end-user. For example, in some embodiments, these training procedures 310 can enable the at least one language model 164 to identify specification parameters 350 that align with best practices and industry standards across heterogenous request specifications 153 and, in some cases that involve supervised training, can leverage the ground-truth labels or annotations provided during the learning process to account for the nuanced and heterogenous nature of the request specifications 153.

Additionally, the specification assembly engine 152 may transmit customized and/or tailored prompts 168 to the language model 164 to identify or extract the specification parameters 350. In some examples, the one or more prompts can be customized or dynamically adjusted based on the content of the contextual data 315 that was collected by the specification assembly engine 152 and some or all of the contextual data 315 can be provided to the language model 164 to enhance its selection or identification of appropriate specification parameters 350. This additional context can further enhance the accuracy of the language model 164 with respect to customizing the specification parameters 350, and can enable the specification assembly engine 152 to account for the unique requirements or objectives of each requesting end-user.

Thus, the communication exchange between the specification assembly engine 152 and the at least one language model 164 can extract or identify specification parameters 350 that align with best practices and industry standards for the particular request specification 153 being assembled and/or which are contextually relevant to the particular request specification 153 being assembled or synthesized.

In step 304, the specification assembly engine 152 incorporates the specification parameters 350 extracted or identified by the language model 164 into the request specification 153 that is being assembled.

In step 305, a parameter synthesis function 330 of the specification assembly engine 152 initiates another communication exchange with the language model 164 to generate or populate content corresponding to each of the specification parameters 350 previously identified or extracted. Again, the parameter synthesis function 330 may transmit one or more customized prompts 168 to the at least one language model 164 to populate the specification parameters 350 with contextually relevant content, and the one or more prompts 168 may be customized or dynamically adjusted to include some or all of the contextual data 315 (e.g., including the contextual data 315 provided by the requesting end-user and/or collected by one or more autonomous agents 180).

In response to receiving the one or more prompts 168, the language model 164 may execute one or more NLP tasks, such as one or more generative tasks 335, to synthesize or generate content for each of the specification parameters 350. In some cases, in executing the one or more generative tasks 335, the at least one language model 164 may generate customized content for each specification parameter 350 using the contextual data 315 obtained in prior steps.

In step 306, the request specification 153 generated by the specification assembly engine 152 can be presented or displayed on the computing device 110A operated by the requesting end-user. The requesting end-user may utilize the first computing device 110A to access, review, modify, and/or revise the request specification 153 generated by the specification assembly engine 152. After the request specification 153 is determined to be complete, the requesting end-user may select an option to approve or confirm the final version of the request specification 153.

The specification synthesis process 300 illustrated in FIG. 3 is merely exemplary and is not limited to the embodiments presented herein. The specification synthesis process 300 can be employed in many different embodiments or examples not specifically depicted or described herein. In some embodiments, the steps of the specification synthesis process 300 can be performed in the order presented. In other embodiments, the steps of the specification synthesis process 300 can be performed in any suitable order. In some embodiments, additional steps can be added to the specification synthesis process 300. In still other embodiments, one or more of the steps of the specification synthesis process 300 can be combined or skipped.

In some exemplary variations of the specification synthesis process 300, the communication exchanges between the specification assembly engine 152 and the language model 164 at steps 303 and 305 can be combined into a single communication exchange. Additionally, the contextual data 315 collected by autonomous agents 180 can be gathered or scraped at various points in time. For example, the data integration system 360 and/or autonomous agents 180 may collect or aggregate the contextual data 315 after a request for a new procurement project 155 is received (step 302) and/or such may be performed as a pre-processing step (e.g., when the requesting entity registers an account with the legal service platform 140). Further variations can be implemented based on the implementation of the language model 164. In some examples, a single language model 164 can be utilized and, in other examples, multiple language models 164 can be used. Additionally, each of the language models 164 can be hosted locally by the legal service platform 140 and/or can be hosted remotely on third-party server systems that are accessed by the AI-powered solicitation system 150 (e.g., by communicating with an API associated with a corresponding language model 164). Many other variations are also possible.

After a requesting end-user has generated a request specification 153, the end-user can send the request specification 153 to service providers, such as legal end-users, registered with the legal service platform 140. The request specification 153 also may be sent to service providers that are not registered with the legal service platform 140.

As explained above, traditional techniques for identifying and selecting service providers largely rely on manual searching and review of candidate service providers, which can result in inefficiencies, limited scalability, and subjective decision-making that often overlooks highly qualified candidates or fails to account for the nuanced requirements of the request specification.

To overcome these and other challenges, the matching engine 154 of the AI-powered solicitation system 150 can execute a process for intelligently matching and ranking service providers in an automated fashion using NLP and/or language model technologies. The process performed by the matching engine 154 can be utilized, inter alia, to conduct an objective, unbiased analysis of service provider data to identify and rank candidate service providers predicted to be best suited for handling or fulfilling request specifications 153. Additionally, unlike manual processes, this process can be instantly performed on a large pool of candidate service providers (e.g., comprising hundreds or thousands of service providers).

FIG. 4 is a flow diagram illustrating an exemplary matching process 400 according to certain embodiments. The matching process 400 may be executed, at least in part, by the matching engine 154 and/or AI-powered solicitation system 150 described herein. While the discussion below primarily describes an exemplary technique for assembling or synthesizing a request specification 153 corresponding to an RFP for legal services, it should be understood that the same or similar technique can be applied to assemble or synthesize other types of request specifications 153 (e.g., such as those that involve RFQs, RFIs, role placement requests, etc.) and/or to assemble or synthesize request specifications 153 other types of services (e.g., accounting services, IT services, etc.).

At step 401, one or more training procedures 410 are applied to the NLP system 162 and/or a language model 164 associated with the NLP system 162. In certain embodiments, the training procedure 410 can be integrated with any other training procedure 410 described in this disclosure (including, but not limited to, training procedures 310 and 510). In certain embodiments, the one or more training procedures 310 may include a supervised, unsupervised, and/or semi-supervised training procedure that trains or fine-tunes the language model 164 to perform the criteria extraction tasks 425, matching tasks 445, ranking tasks 455, and/or other NLP tasks described in this disclosure.

In some embodiments, a training procedure 410 may be applied that utilizes domain-specific data corresponding to candidate provider data (e.g., identifying details, profiles, and/or capabilities of attorney or law firm profile information), request specifications 153, response proposals 157, and/or other data that is useful for understanding service provider capabilities and/or matching service providers to request specifications 153. In some examples, the domain-specific data may include a dataset comprising historical request specifications, candidate service provider data, and/or outcomes of service provider selections made by requesting end-users with respect to fulfilling request specifications 153. In some embodiments, the one or more training procedures 410 applied to train or fine-tune the language model 164 may comprise a supervised training procedure 410 that utilizes ground-truth labels or annotations inserted into in the dataset, such as ground-truth labels or annotations that include matching scores or indicators assigned to candidate service data for each service provider, which indicate the suitability of a corresponding legal end-user in fulfilling one or more request specifications 153. This labeled training dataset may be fed into the language model 164 to hone the ability of the model 164 to perform the criteria extraction tasks 425, matching tasks 445, ranking tasks 455, and/or other NLP tasks described in this disclosure.

Additionally, or alternatively, the training procedure 410 also may incorporate continuous learning and/or reinforcement learning mechanisms. In some examples, the matching engine 154 may collect feedback from requesting end-users with respect to the quality of historical matches and/or ranking of service providers (and/or actual service provider selections that were made by the requesting end-users), and this data may be applied to continuously or periodically refine the training of the language model 164.

In certain embodiments, the one or more training procedures 410 (and/or associated training data) can enhance the ability of the language model 164 to understand nuances in matching service providers with specification parameters 350 for different types of request specifications 153, such as industry-specific parameters, practice area-specific parameters, standard parameters commonly associated with legal request specifications, etc.

In step 402, a requesting end-user initiates a request to obtain service provider matches (e.g., attorney or law firm providers) for a request specification 153 (or corresponding procurement project 155). The request is received by the matching engine 154 and may include a copy of the request specification 153. In some examples, the requesting end-user may represent a client end-user that is seeking to identify legal end-users that are best suited to handle the request specification 153. Any data that is generated by the matching process 400 can be stored and associated with the procurement project 155 corresponding to the request specification 153.

In step 403, the data integration system 360 retrieves or collects candidate provider data corresponding to legal-end users and/or other types of service providers. The candidate provider data may generally include any data associated with a legal end-user or service provider. In some examples, the candidate provider data for each legal end-user may comprise details about legal capabilities and practice areas, attorney profiles, educational experience, office locations, prior legal experience, prior cases or legal proceedings, publications authored by the legal end-user, client reviews or ratings associated with the legal end-user, news articles associated with the legal end-user, and/or other data relating to the legal end-user.

In some examples, the data integration system 360 may access or retrieve the candidate provider data from one or more databases that store platform profile data 415, which corresponds to service provider profiles (e.g., attorney profiles or law firm profiles) associated with registered accounts on the legal service platform 140. In other examples, the data integration system 360 may access or retrieve the candidate provider data from one or more web resources 340 (e.g., which may include online legal directories, firm websites, public databases, electronic court filing systems, etc.). As explained in other portions of this disclosure, the data integration system 360 may utilize one or more autonomous agents 180 to retrieve or collect some or all of the candidate provider data. Additionally, in some embodiments, the one or more autonomous agents 180 may include, or communicate, with a language model 164 to analyze, interpret, condense, and/or reformat the collected data, transforming unstructured or semi-structured information into structured formats that can be seamlessly integrated into the operations of the matching engine 154.

In step 404, a criteria extraction function 430 of the matching engine 154 initiates a communication exchange with the language model 164 to extract or identify selection criteria 436 corresponding to the request specification 153 being assembled or synthesized. In this communication exchange, the criteria extraction function 430 may transmit one or more prompts 168 that are tailored to extract contextually relevant selection criteria 436, which may include a copy of the request specification 153 and/or an instruction that commands or causes the language model 164 to identify or extract a set of selection criteria. In some embodiments, the one or more prompts 168 also may include an instruction that commands or causes the language model 164 to rank the extracted selection criteria from most important to least important. The one or more prompts 168 also may include some or all of the contextual data 315 provided by the requesting end-user in creating the request specification 153, such as contextual data 315 that indicates the importance of various specification parameters 350 and/or that describes unique specification parameters 350 inserted by the requesting end-user.

In response to receiving one or more prompts 168, the language model 164 may execute one or more criteria extraction tasks 425 that are configured to identify or extract the corresponding selection criteria 436 from the request specification 153. In some examples, the one or more criteria extraction tasks 425 may analyze each specification parameter 350 included in the request specification 153 that solicits information from a service provider and supplement the selection criteria 436 with a corresponding criterion.

In general, each selection criterion 436 may correspond to a data point, attribute, or characteristic that can be utilized to match the compatibility or suitability of a legal end-user or other service provider with the request specification 153. In some examples, the selection criteria 436 may include some or all of the following:
a) a minimum experience attribute indicating a minimum level of experience or a minimum number of years practicing law;
b) one or more practice area attributes indicating practice areas (e.g., real estate law, contract law, litigation, etc.) that apply to the services being solicited in the request specification 153 and/or practice areas that are offered by service providers;
c) geographic location attributes specifying the preferred or required location of the service provider, such as proximity to the client or jurisdictional expertise;
d) educational background attributes indicating the academic qualifications of the service provider, including law school, degrees, certifications, or specialized training;
e) technological capability attributes indicating the service provider's integration or proficiency with legal technology tools, such as e-discovery platforms, document automation systems, or case management software;
f) client review attributes indicating minimum ratings or scores for the service providers (which may be based on feedback, ratings, or testimonials from previous client end-users);
g) publication attributes indicating the desire for well-published service providers (which may consider the extent to which the service providers have authored articles, books, or presentations on particular subjects or legal issues);
h) conflict of interest attributes which may require service providers to confirm clearance of potential conflicts with specific entities and/or which may require service providers to incorporate specific types of conflict policies;
i) availability attributes specifying the expected level of responsiveness and availability for the project or matter associated with the request specification 153; and/or
k) pricing structure attributes specifying the preferred or required fee arrangements, such as hourly rates, flat fees, contingency fees, alternative fee arrangements (AFAs), or subscription-based models, as well as any budget constraints or expectations for cost transparency and detailed billing practices.

Some or all of the selection criteria 436 may correspond to, or be derived from an analysis of, the specification parameters 350 included in the request specification 435. Many other types of selection criteria 436 also may be extracted by the criteria extraction tasks 425, including unique or custom criteria that may be inserted by a requesting end-user into the request specification 153.

In some embodiments, the criteria extraction function 430 can utilize the selection criteria 436 extracted by the language model 164 to construct or generate a benchmark profile 434, which may represent the ideal profile or attributes of a service provider for the request specification 153. The benchmark profile 434 may include each of the selection criteria 436 extracted by the language model 164 and/or a predicted importance of each of the selection criteria 436. This benchmark profile 434 can be utilized by the matching engine 154 to identify and/or rank legal end-users or other service providers.

In certain embodiments, the benchmark profile 434 can include a structured representation of the attributes and/or qualifications deemed most suitable for fulfilling the request specification. This profile may include various categories of attributes (e.g., such as attorney titles, specialties, practice areas, geographic locations, years of experience, educational background, professional recognition, technological capabilities, diversity metrics, and client reviews). In certain embodiments, some or all of the attributes incorporated within the benchmark profile 434 can be associated with an explanation generated by the language model 164, providing context and/or justification for its inclusion. The structured format of the benchmark profile 434 facilitates consistency and enables interoperability with other system components.

Additionally, in certain embodiments, the benchmark profile 434 may incorporate nuanced requirements extracted from the request specification 153, such as specific legal expertise, jurisdictional knowledge, responsiveness expectations, and preferred pricing structures. By leveraging the benchmark profile 434, the matching engine 154 can perform a targeted and holistic assessment of candidate service providers, ensuring alignment with the unique objectives and constraints of the requesting end-user.

In certain embodiments, the criteria extraction function 430 may execute or impose a constrained contextual analysis 432 on the selection or identification of some or all of the attributes incorporated into the selection criteria 436. The constrained contextual analysis 432 can confine or constrain the language model's selection of the selection criteria 436 by requiring the language model 164 to select the selection criteria 436 from pre-defined categories of permissible attributes. In one example, for a selection criterion 436 indicating a title preference or requirement, the constrained contextual analysis 432 may impose constraints requiring the selection criteria 436 to be a single attribute selected from one of the following: partner, associate, counsel, freelance, or paralegal.

In another example, for a selection criterion 436 related to practice areas, the constrained contextual analysis 432 may require the language model 164 to select one or more practice areas from pre-defined categories, such as intellectual property law, real estate law, contract law, litigation, employment law, or family law. In another example, for a selection criterion 436 related to fee arrangements, the constrained contextual analysis 432 may require the language model 164 to select a pricing structure from pre-defined categories, such as hourly rates, flat fees, contingency fees, alternative fee arrangements (AFAs), or subscription-based models. In another example, for a selection criterion 436 related to geographic location, the constrained contextual analysis 432 may require the language model 164 to select a location attribute from pre-defined categories such as city, state, region, or jurisdiction, and may further specify proximity requirements, such as within a certain radius of the client's office or within a particular legal jurisdiction. In another example, for a selection criterion 436 related to years of experience, the constrained contextual analysis 432 may require the language model 164 to select an experience range from pre-defined categories, such as 0-5 years, 6-10 years, 11-15 years, or more than 15 years.

These categories may be stored in a structured format, such as a configuration file, database table, or serialized object, and may be provided to the language model 164 as contextual information during the performance of the criteria execution tasks 425. The constrained contextual analysis 432 may be configured to guide the language model 164 in selecting contextually relevant attributes from the pre-defined categories, preventing overly broad or irrelevant interpretations of the request specification 153. The structured representation resulting from the constrained contextual analysis 432 can facilitate consistency in the selection criteria 436 and interoperability with other components of the system. Additionally, the benchmark profile 434 can incorporate the structured selection criterion 436 to facilitate matching with service providers.

In certain embodiments, the candidate provider data accessed or retrieved by the data integration system 360 can be processed in a similar manner to generate or derive a structured representation for each legal end-user or service provider. For example, the language model 164 can process the candidate provider data corresponding to each legal end-user or service provider using the same or similar constrained contextual analysis technique described above in order to generate a structured representation for each, which comprises attributes selected from pre-defined categories. This processing of the candidate provider data can enable searches and matches to be performed more rapidly and more efficiently.

In step 406, a candidate matching function 440 of the matching engine 154 initiates another communication exchange with the language model 164 that attempts to identify the one or more legal end-users or other service providers that are best suited for the request specification 153. In this communication exchange, the candidate matching function 440 may transmit one or more prompts 168 that are tailored to facilitate the accurate identification of service providers that are best aligned with the selection criteria 436. In some embodiments, the one or more prompts 168 also may include an instruction that commands or causes the language model 164 to search the candidate provider data obtained by the data integration system 360 to identify a subset of candidate service providers that match or substantially match the benchmark profile 434 and/or selection criteria 436 associated therewith.

In response to receiving one or more prompts 168, the language model 164 may execute one or more matching tasks 445, which analyze the candidate provider data corresponding to each of the service providers to determine their alignment with the benchmark profile 434 and/or selection criteria 436 associated therewith. In some examples, the one or more matching tasks 445 may analyze the candidate provider data corresponding to each service provider to determine whether the corresponding service provider is in alignment with each of the selection criteria 436 included in the benchmark profile 434. As mentioned above, in some embodiments, the candidate provider data can be arranged in a structured representation that facilitates rapid matching and comparison with the selection criteria 436 included in the benchmark profile 434. In certain embodiments, the selection of the service providers also may consider importance scores or indicators that are associated with each of the selection criteria 436.

After analyzing the candidate provider data corresponding to the service providers, the language model 164 may return a set of predicted candidate matches 250 to the matching engine 154. The predicted candidate matches 250 may identify a subset of legal end-users or other service providers that are predicted to be the best matches for the request specification 153.

In certain embodiments, the candidate matching function 440 and/or language model 164 can execute a prioritized matching function 442 to identify the predicted candidate matches 250 in a manner that optimizes speed and reduces computation requirements, which may require significant resources and time in scenarios where large quantities of service providers (e.g., thousands) are initially included in the pool of potential candidate matches. The prioritized matching function 442 may implement a multi-tier search strategy to identify service providers that align with the benchmark profile 434.

Initially, the prioritized matching function 442 may perform a direct match query using a subset of highly relevant attributes from the benchmark profile 434, such as practice areas, years of experience, geographic location, and/or other selection criteria deemed to be important. This direct match query can be aimed at rapidly identifying highly suitable service providers that align with all or most of the selection criteria 436 determined to be most important. If one or more direct matches are identified, then they may be incorporated into the predicted candidate matches 250. However, if the direct match query yields few or no results, a second tier of search is performed by the prioritized matching function 442 may relax the query by adding additional attributes and/or broadening the selection criteria 436 to include fewer specific parameters. Additionally, if the broader search fails to produce sufficient results, a third tier of the search performed by the prioritized matching function 442 may resort to querying a cached or general database of service providers, ranking the results based on a general relevancy score derived from the available data.

The prioritized matching function 442 may also interplay with the data collection techniques employed by the data integration system 360. In certain embodiments, the data integration system 360 can retrieve candidate provider data in real-time or near real-time from multiple data sources (e.g., including structured databases, external APIs, and internal data stores) as opposed to retrieving this data as a pre-processing step. In these scenarios, the data integration system 360 may transmit queries to the data sources (e.g., web resources 340 and/or platform profile data 415) according to the multi-tier search paradigm described above. For example, the data integration system 360 may initially utilize a direct match query to search the data sources in attempting to quickly identify direct matches on service providers, and then may resort the broader queries in the second and third tiers of the matching process if necessary.

Additionally, or alternatively, the prioritized matching function 442 may utilize the structured data representations generated by the data integration system 360 to refine its queries and improve the accuracy of the matching process in scenarios where the data integration system 360 processes the candidate provider data into structured representations. For example, the data integration system 360 may utilize the structured representations to perform targeted searches and rank service providers based on their alignment with the benchmark profile 434. Additionally, the data integration system 360 may dynamically update the candidate provider data, allowing the prioritized matching function 442 to incorporate the most current and relevant information into its matching process.

Other techniques also may be employed by the matching engine 154 to identify the predicted candidate matches 250.

In step 408, a candidate ranking function 450 may optionally be executed. The candidate ranking function 450 initiates another communication exchange with the language model 164 that attempts to rank or score the legal end-users or service providers included in the predicted candidate matches 250 from most relevant to least relevant. In this communication exchange, the candidate ranking function 450 may transmit one or more prompts 168 that are tailored to facilitate the precise ranking or ordering of the matched service providers. In certain embodiments, the one or more prompts 168 may include the structured representation of the benchmark profile 434 indicating the ideal service provider match and the structured representations corresponding to the candidate service providers. Additionally, in some embodiments, the one or more prompts 168 also may include an instruction that commands or causes the language model 164 to rank or order the service by performing a holistic assessment that considers all available selection criteria 436 (e.g., experience, practice areas, location, education, publications, etc.) and/or which considers importance indicators corresponding to the selection criteria 436. In some embodiments, the one or more prompts 168 also may include an instruction to provide a reasoned justification for the ranking.

In response to receiving one or more prompts 168, the language model 164 may execute one or more ranking tasks 455 that can analyze the attributes of the service providers identified by the predicted candidate matches 250. In some examples, the one or more matching tasks 445 may analyze the candidate provider data corresponding to each service provider in order to perform a holistic analysis of the service provider's alignment with the selection criteria 436 included in the benchmark profile 434. In certain embodiments, the ranking or ordering of the service providers also may consider importance scores or indicators that are associated with each of the selection criteria 436. After the ranking or order of the service providers is determined, the language model 164 may return a ranked or ordered set of the predicted candidate matches 250 to the matching engine 154.

In step 408, the requesting end-user may utilize the first computing device 110A to access, review, modify, and/or revise the predicted candidate matches 250 generated by the matching engine 154, which may optionally be ranked or ordered as described above. In some examples, the requesting end-user may approve the predicted candidate matches 250, may add one or more additional service providers to the predicted candidate matches 250, and/or may remove one or more service providers. In some cases, the predicted candidate matches 250 presented to the requesting end-user also may include details about each of the corresponding service providers (e.g., relevant experience, geographic location, etc.) and/or may highlight aspects of the service providers which align with the specification parameters 350 and/or section criteria 436 associated with the request specification 153.

In response to the requesting end-user finalizing or approving the candidate matches 250, the AI-powered solicitation system 150 may transmit the request specification to each of the legal end-users or service providers included in the candidate matches 250.

The functionalities of the matching engine 154 set forth in this disclosure are rooted in computer technologies that overcome existing problems in traditional service provider matching and selection techniques, including problems dealing with the manual review and selection of large collections of service providers (e.g., which often results in many highly suitable service providers being overlooked or not considered). The techniques described in this disclosure provide a technical solution (e.g., one that utilizes NLP and/or language model technologies) for overcoming the limitations associated with known techniques. This technology-based solution marks an improvement over existing capabilities and functionalities, and facilitates accurate matching on large datasets or service providers in a holistic fashion and in an objective manner that does not interject bias into the evaluation of the service providers.

In addition to leveraging AI technologies to facilitate service provider matching and ranking, the techniques employed by the matching engine 154 can integrate several notable technical improvements. For example, embodiments that apply the constrained contextual analysis 432 provide an improved technique for controlling the output of a language model by confining its selection of attributes to pre-defined categories. This approach results in highly accurate and contextually relevant search results while preventing the language model from generating overly broad, irrelevant, or inconsistent interpretations of the request specification 153. By framing the language model's analysis within structured parameters, the constrained contextual analysis 432 enhances the precision and reliability of the selection criteria 436.

Additionally, testing results have found that embodiments that utilize a holistic analysis approach during the ranking process enable the system to evaluate service providers in a manner that mimics the complex, multi-faceted decision-making of a human expert. This approach allows the system to consider a wide range of attributes while providing significantly greater speed, objectivity, and consistency compared to manual evaluations. By leveraging this holistic analysis, the matching engine 154 can generate rankings that are both comprehensive and unbiased, improving the overall quality of the candidate matches.

Furthermore, for embodiments that incorporate the prioritized matching function 442, the multi-tier search algorithm associated therewith is optimized for both speed and relevance. By initially performing direct match queries on highly relevant attributes and progressively broadening the search criteria only when necessary (e.g., when no direct matches are identified or the number of direct matches do not exceed a threshold number of matches), the prioritized matching function 442 can avoid undue processing and storage requirements associated with retrieving, storing, and/or analyzing the candidate provider data. In many scenarios (including those which involve large-scale databases encompassing large quantities of service provider data), this approach allows the system to rapidly and efficiently identify highly suited service providers while significantly reducing computational resources.

The matching process 400 illustrated in FIG. 4 is merely exemplary and is not limited to the embodiments presented herein. The matching process 400 can be employed in many different embodiments or examples not specifically depicted or described herein. In some embodiments, the steps of the specification matching process 400 can be performed in the order presented. In other embodiments, the steps of the matching process 400 can be performed in any suitable order. In some embodiments, additional steps can be added to the matching process 400. In still other embodiments, one or more of the steps of the matching process 400 can be combined or skipped.

In some exemplary variations of the matching process 400, the communication exchanges between the matching engine 154 and the language model 164 at steps 404, 406, and 407 can be combined into a single communication exchange (or combined in various ways). Additionally, the service provider data collected by the data integration system 360 can be retrieved, gathered, or collected at various points in time. For example, the data integration system 360 may access or retrieve the service provider data in real-time or near real-time during the matching process 400 and/or it may be accessed or retrieved as a pre-processing step. Further variations can be implemented based on the implementation of the language model 164. In some examples, a single language model 164 can be utilized and, in other examples, multiple language models 164 can be used. Additionally, each of the language models 164 can be hosted locally by the legal service platform 140 and/or can be hosted on third-party server systems that are accessed by the AI-powered solicitation system 150 (e.g., by communicating with an API associated with a corresponding language model 164). Many other variations also are possible. Furthermore, the language models 164 utilized in the matching process 400 can be the same language models used in other processes (e.g., processes 300 or 500) and/or can be different language models 164.

After a requesting end-user has generated a request specification 153, the end-user can send the request specification 153 to service providers, such as legal end-users, registered with the legal service platform 140. The request specification 153 also may be sent to service providers that are not registered with the legal service platform 140. Each of the legal end-users or service providers that receive the request specification 153 can be permitted to generate and transmit response proposals 157 corresponding to the request specification 153 back to the requesting end-user for review and consideration in selecting a service provider to fulfill the request specification 153.

As explained above, traditional techniques for generating the response proposals 157 largely rely on the manual collection of information and manual drafting efforts, which present several technical challenges. Amongst other things, the process of manually gathering relevant data, such as prior case experience, pricing structures, and/or jurisdictional expertise, is time-consuming and prone to errors or omissions. Additionally, service providers often need to sift through extensive historical records, databases, and/or documents to extract pertinent information, which can lead to inefficiencies and inconsistencies in the response proposals and/or which can result in important details being overlooked.

Additionally, the variability and complexity of request specifications exacerbate these challenges. Each request specification may include unique criteria, such as specific fee arrangements, geographic proximity requirements, or compatibility with certain technological systems, which should be addressed in the response proposals 157. Without advanced tools or methodologies, service providers may struggle to tailor their proposals to meet these nuanced requirements, resulting in generic or suboptimal responses that fail to align with the objectives of the requesting entity.

Moreover, the manual drafting process often requires significant expertise and attention to detail to ensure that the response proposal is comprehensive, accurate, and persuasive. This can be particularly challenging for service providers that are not experienced with responding to request specifications, or particular types of request specifications (e.g., specific to particular types of legal issues or practice areas). Without this domain knowledge, the response proposals 157 are likely to be suboptimal and/or may overlook or underemphasize important considerations that should be addressed. Overlooking or misinterpreting details of a request specification can undermine the effectiveness of the response proposal.

Furthermore, traditional methods lack the ability to leverage historical data, market trends, or predictive analytics to optimize response proposal details, such as in connection with predicting pricing or resource allocations for a project and/or with respect to offering AFAs or different pricing structures that can render a response proposal more attractive to a requesting end-user. This limitation can result in proposals that are either overly conservative or excessively ambitious, failing to strike the right balance between competitiveness and feasibility. These challenges highlight the need for automated or semi-automated systems that can streamline the proposal drafting process, assist service providers in generating tailored and contextually relevant responses, and ensure alignment with the specific requirements of the request specification.

FIG. 5 is a flow diagram illustrating an exemplary proposal synthesis process 500 according to certain embodiments. The proposal synthesis process 500 may be executed, at least in part, by the proposal synthesis engine 156 and/or AI-powered solicitation system 150 described herein. While the discussion below primarily describes an exemplary technique for assembling or synthesizing a response proposal 157 corresponding to an RFP for legal services, it should be understood that the same or similar technique can be applied to assemble or synthesize other types of request specifications 153 (e.g., such as those that involve RFQs, RFIs, role placement requests, etc.) and/or to assemble or synthesize request specifications 153 other types of services (e.g., accounting services, IT services, etc.).

At step 501, one or more training procedures 510 are applied to the NLP system 162 and/or a language model 164 associated with the NLP system 162. In certain embodiments, the training procedure 510 can be integrated with any other training procedure described in this disclosure (including, but not limited to, training procedures 410 and 310). The one or more training procedures 510 may include a supervised, unsupervised, and/or semi-supervised training procedure that trains or fine-tunes the language model 164 to perform the parameter extraction tasks 325, generative tasks 335, and/or other NLP tasks described in this disclosure.

In some embodiments, a training procedure 510 may be applied that utilizes domain-specific data comprising a dataset of request specifications 153 and/or response proposals 157 and, in some cases, historical request specifications and/or response proposals that were utilized in previous proposal solicitation processes (e.g., conducted on the legal service platform 140 and/or outside of the legal service platform 140). In some embodiments, the one or more training procedures 510 applied to train or fine-tune the language model 164 may comprise a supervised training procedure that utilizes ground-truth labels or annotations inserted into the request specifications in the dataset, such as ground-truth labels or annotations identifying a proposal parameters, fields, or sections of response proposals 157. This labeled training dataset may be fed into the language model 164 to hone the ability of the model 164 to perform the parameter extraction tasks 525, generative tasks 535, and/or other NLP tasks.

In step 502, a service provider end-user initiates a request to construct or assemble a response proposal 157 corresponding to a request specification 153. The request is received by the proposal synthesis engine 156 and may include a copy of the request specification 153. In some examples, the service provider end-user may represent a legal service provider (e.g., an attorney or law firm) that is seeking to respond to a request for legal services in connection with a procurement project 155. Any data that is generated by the proposal synthesis process 500 can be stored and associated with the procurement project 155 corresponding to the request specification 153.

In step 503, the data integration system 360 retrieves, collects, or accesses candidate provider data 530 corresponding to the legal end-user and/or service provider end-user that issued the request for a response proposal 157. As explained above, the candidate provider data 530 for the service provider may generally include any data associated with the service provider and/or the capabilities of the service provider with respect to providing services. In some examples, the candidate provider data 530 for the legal end-user may include service provider identification information (e.g., which identifies the firm or attorney), legal service capability data (e.g., indicating the services, specialties, expertise, and/or practice areas of the legal end-user), profile information for the legal end-user (e.g., which may be obtained from the legal end-user's profile on the platform 140), educational experience corresponding to the legal end-user, office location details, historical data or prior legal experience, prior cases or legal proceedings, publications authored by the legal end-user, client reviews or ratings associated with the legal end-user, news articles associated with the legal end-user, and/or other data relating to the legal end-user.

As explained above, the data integration system 360 may access or retrieve the candidate provider data 530 from one or more databases that store platform profile data 415 and/or may access or retrieve the candidate provider data 530 from one or more web resources 340 (e.g., which may include online legal directories, firm websites, public databases, electronic court filing systems, new publications, etc.). As explained in other portions of this disclosure, the data integration system 360 may utilize one or more autonomous agents 180 to retrieve or collect some or all of the candidate provider data 530. Additionally, in some embodiments, the one or more autonomous agents 180 may include, or communicate, with a language model 164 to analyze, interpret, digest, condense, and/or reformat the collected data, transforming unstructured or semi-structured information into structured formats that can be seamlessly integrated into the operations of the proposal synthesis engine 156.

In step 504, a proposal construction function 520 of the proposal synthesis engine 156 initiates a communication exchange with the language model 164 to extract or identify proposal parameters 550 corresponding to the response proposal 157 being assembled or synthesized. In this communication exchange, the proposal construction function 520 may transmit one or more prompts 168 that are tailored to extract contextually relevant proposal parameters 550. The exchange may provide the language model 164 with a copy of the request specification 153 and/or an instruction that commands or causes the language model 164 to identify or extract a set of proposal parameters 550.

In response to receiving one or more prompts 168, the language model 164 may execute one or more parameter extraction tasks 525 that are configured to identify or extract the corresponding proposal parameters 550 from the request specification 153. In general, the proposal parameters 550 may correspond to data points, fields, variables, sections, and/or attributes to be incorporated into the response proposal 157 being assembled. The proposal parameters 550 extracted by the language model 164 may correspond to, or be derived from, any of the specification parameters 350 and/or selection criteria 436 described above.

In some examples, the proposal parameters 550 may include some or all of the following: a) a service provider parameter that identifies the service provider (and/or provides relevant details about associated with attorneys and the associated law firm); b) an experience parameter that provides details on the service provider's prior experience with handling similar matters (e.g., including representative cases, outcomes, etc.); c) a jurisdictional parameter that specifies the courts, geographic regions, and/or legal jurisdictions where the service provider is licensed to practice; d) a timeline parameter that indicating the service provider's expected duration of the project or milestones and deadlines for deliverables; e) a remuneration structure parameter that offers one or more proposed billing arrangements, such as hourly rates, flat fees, alternative fee arrangements (AFAs), or contingency fees; f) a conflict of interest parameter that identifies any potential conflicts of interest on the part of the service provider and/or lack thereof; g) a technology and innovation parameter indicating technology solutions utilized or proposed by the service provider for the specific request specification 153; h) a plan of action parameter that identifies the service provider's proposal plan of action for handling the legal issue that is the subject of the request specification 153.

At step 505, after the language model 164 has identified the proposal parameters 550 to be included in the response proposal 157, the proposal construction function 520 initiates another communication exchange with the language model 164 to generate content corresponding to each of the identified proposal parameters 550. In this communication exchange, the proposal construction function 520 may transmit one or more prompts 168 that are tailored to generate customized content for each proposal parameter 550. The exchange may provide the language model 164 with some or all of the candidate provider data 530 corresponding to the service provider for which the response proposal 157 is being created and/or one or more instructions that command or cause the language model 164 to generate custom content for each proposal parameter 550 in a manner that incorporates the candidate provider data 530 and/or personalizes the content to the service provider. The language model 164 may execute one or more generative tasks 535 in connection with populating the content for each of the proposal parameters 550.

For example, during the communication exchange at step 505, the proposal construction function 520 may identify an experience parameter as one of the proposal parameters 550 to be included in the response proposal 157. In this scenario, the proposal construction function 520 can transmit a tailored prompt 168 to the language model 164, instructing it to generate content for the experience parameter by incorporating relevant details from the candidate provider data 530. This data may include the service provider's prior case history, representative matters, specific outcomes achieved in similar legal matters, and/or the number of years of experience in relevant practice areas. For instance, if the request specification 153 pertains to intellectual property litigation, the prompt may direct the language model 164 to highlight the service provider's experience in handling patent infringement cases, including a summary of notable cases, jurisdictions involved, and successful outcomes. The language model 164 executes a generative task 535 to synthesize this information into a cohesive and persuasive narrative, ensuring that the content is tailored to the specific requests of the request specification 153. The resulting content may emphasize the service provider's expertise in intellectual property law, their track record of favorable case resolutions, and their ability to navigate complex legal and technical issues, thereby aligning the response proposal 157 with the objectives and evaluation criteria outlined in the request specification.

The same or similar process can be applied to identify and populate content for each of the proposal parameters 550 extracted by the language model 146.

Additional complexities can be involved with generating the content for certain types of parameters, such as pricing and remuneration structure parameters. This can be attributed, at least in part, to the variability in pricing for legal services and/or other types of services, as well as varying types of fee structures and/or remuneration structures that can be applied to specific types of legal projects (e.g., which can range from simpler flat fee or hourly billing models to complex alternative fee arrangements that involve contingency arrangements and/or third-party funding). Generating contextually relevant content for these parameters can extend beyond the synthesis of candidate provider data 530, and failing to incorporate additional contextually relevant data, processing steps, and/or training processes can result in suboptimal results with respect to generating the content for these types of proposal parameters 550.

To address the technical challenges associated with controlling or guiding a language model 164 to synthesize contextually relevant content for these parameters, several enhancements can be incorporated into the proposal synthesis engine 156 (or remuneration modeling engine 158 associated therewith).

In certain embodiments, the training procedure 510 applied to the language model 146 can be enhanced to hone the precision of the language model 146 in connection with generating pricing parameters and/or remuneration structure parameters. In some examples, the training procedure 510 may incorporate domain-specific datasets that include historical billing data, case complexity metrics, client profiles, and/or market trends. Additionally, these datasets can be annotated with ground-truth labels that identify correlations between case characteristics and billing outcomes, enabling the language model 164 to learn patterns and relationships that influence pricing strategies. Additionally, supervised learning techniques can be employed to train the language model 164 to predict the time, effort, and resources required for various legal tasks, based on historical data and contextual factors.

To further enhance the training procedure, feedback loops can be integrated into the system to continuously refine the language model 164. For instance, the model can be updated based on real-world outcomes of implemented fee arrangements, such as client satisfaction scores, profitability metrics, and deviations from predicted costs. This iterative learning process allows the language model 164 to improve its predictive accuracy over time, ensuring that the generated pricing parameters and remuneration structures remain competitive and aligned with client expectations.

Moreover, in certain embodiments, the training procedure 510 can include specialized modules for modeling alternative fee arrangements (AFAs), such as fixed fees, capped fees, contingency fees, subscription-based models, and/or third-party funding options. By analyzing historical data on the performance and client reception of these AFAs, the language model 164 can be trained to generate tailored fee structures that optimize both client satisfaction and law firm profitability. This enhanced training approach ensures that the language model 164 is equipped to handle the variability and complexity of legal pricing, providing precise and contextually relevant outputs for inclusion in response proposals 157.

In certain embodiments, one or more machine learning models 560 also may be incorporated into the AI architecture 160 of the AI-powered solicitation system 150 to perform the same or similar functionalities described above. For example, a machine learning model 560 may be trained on some or all of the data mentioned above, including the historical billing data, case complexity metrics, client profiles, and prevailing market trends to identify patterns and correlations between case characteristics and billing outcomes. By leveraging these insights, the machine learning model 560 can be trained to predict the estimated time, effort, and resources required for various legal tasks, enabling the generation of optimized pricing strategies tailored to specific request specifications.

Additionally, the machine learning model 560 may be configured to model alternative fee arrangements (AFAs), such as fixed fees, capped fees, contingency fees, and subscription-based models. By analyzing historical data on the performance and client receptiveness of these AFAs, the machine learning model 560 can generate tailored fee structures that align with client preferences while optimizing law firm profitability. The model may also incorporate feedback loops to refine its predictions over time, using real-world outcomes of implemented fee arrangements—such as client satisfaction scores, profitability metrics, and/or deviations from predicted costs—to continuously improve its accuracy and relevance.

Furthermore, the machine learning model 560 may integrate with a service provider's existing billing and case management software to retrieve and process data in real-time or near real-time. This integration allows the model to dynamically update its predictions and recommendations based on the most current information, ensuring that the generated pricing parameters and remuneration structures remain competitive and contextually relevant. By incorporating these advanced capabilities, the machine learning model 560 enhances the AI-powered solicitation system's ability to streamline the proposal synthesis process and deliver tailored, data-driven pricing strategies.

Any appropriate machine learning model 560 can be employed to perform the aforementioned functions. In some examples, the machine learning model 560 can comprise a support vector machine (SVM) model, an ensemble learning model, a clustering model (e.g., such as a k-means clustering or hierarchical clustering model), decision tree model, random forest model, a gradient-boosted model, and/or other appropriate model.

In step 504, the remuneration modeling engine 158 and/or the proposal construction function 520 of the proposal synthesis engine 156 initiates a communication exchange with the AI architecture 160 to solicit data for populating the content of the pricing parameters and/or remuneration modeling parameters to be incorporated into the response proposal.

In some examples, a communication exchange may be initiated with the language model 164 to generate the content for these proposal parameters 550. In this communication exchange, the proposal construction function 520 may transmit one or more prompts 168 with an instruction that commands or causes the language model 164 to identify potential pricing and price model options, which may consider industry pricing trends, predicted time and resource allocations, and/or the service provider's willingness to extend certain types of pricing models or AFAs.

Additionally, or alternatively, the pricing parameters and/or remuneration modeling parameters may be generated, at least in part, based on the outputs of the machine-learning model 560. In some examples, the communication exchange may transmit certain parameters, metrics, or data project pertaining to service or project associated with the request specification 153 to the machine-learning model 560, and the parameters, metrics, or data may be received as inputs to a pre-trained algorithm executed by the machine-learning model 560 to predict the time, resources, and/or pricing for the project. In turn, the outputs of the machine-learning model 560 can be utilized (e.g., by the language model 164) to formulate more complex fee modeling arrangements, including various types of AFAs.

Other techniques also may be utilized to generate the content for the pricing parameters and/or remuneration modeling parameters that are incorporated into the response proposal 157.

At step 507, the proposal synthesis engine 156 incorporates each of the proposal parameters 550 (and their corresponding content) into the response proposal 157 being assembled or synthesized.

At step 508, the service provider end-user may utilize the computing device 110B to access, review, modify, and/or revise the response proposal 157 generated by the proposal synthesis engine 156 using one or more front-end interfaces 145. Once finalized, the service provider end-user may approve the response proposal 157 and transmit the response proposal 157 to the requesting end-user for review or consideration.

The proposal synthesis process 500 illustrated in FIG. 5 is merely exemplary and is not limited to the embodiments presented herein. The proposal synthesis process 500 can be employed in many different embodiments or examples not specifically depicted or described herein. In some embodiments, the steps of the synthesis process 500 can be performed in the order presented. In other embodiments, the steps of the synthesis process 500 can be performed in any suitable order. In some embodiments, additional steps can be added to the synthesis process 500. In still other embodiments, one or more of the steps of the synthesis process 500 can be combined or skipped.

In some exemplary variations of the synthesis process 500, the communication exchanges between the proposal synthesis engine 156 and the language model 164 at steps 504, 505, and 506 can be combined into a single communication exchange (or combined in various ways). Additionally, the candidate provider data 530 collected by the data integration system 360 can be retrieved, gathered, or collected at various points in time. For example, the data integration system 360 may access or retrieve the candidate provider data 530 in real-time or near real-time during the process 500 and/or it may be accessed or retrieved as a pre-processing step. Further variations can be implemented based on the implementation of the language model 164. In some examples, a single language model 164 can be utilized and, in other examples, multiple language models 164 can be used. Additionally, each of the language models 164 can be hosted locally by the legal service platform 140 and/or can be hosted on third-party server systems that are accessed by the AI-powered solicitation system 150 (e.g., by communicating with an API associated with a corresponding language model 164). Many other variations also are possible. Furthermore, the language models 164 utilized in the matching process 400 can be the same language models used in other processes (e.g., processes 400 or 500) and/or can be different language models 164.

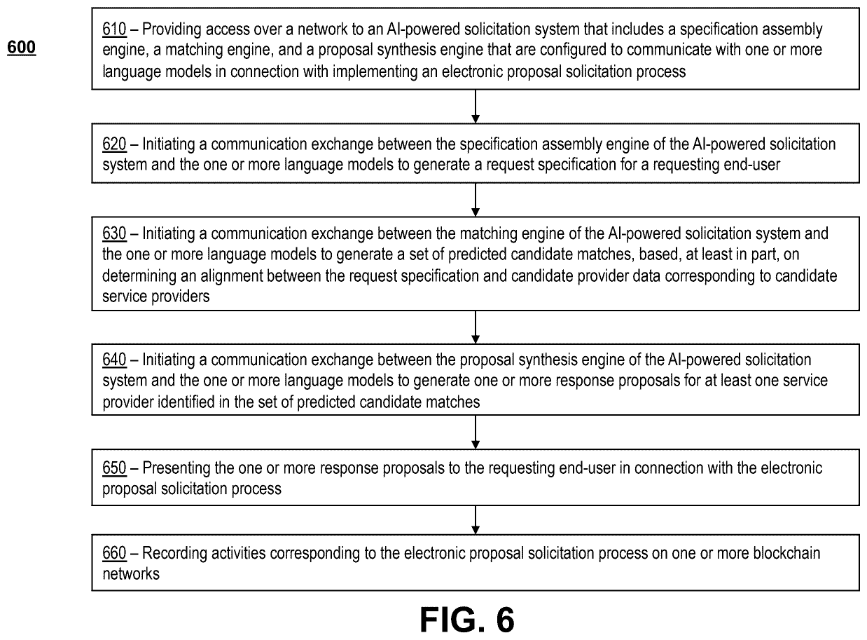

FIG. 6 illustrates a flow chart for an exemplary method 600 according to certain embodiments. Method 600 is merely exemplary and is not limited to the embodiments presented herein. Method 600 can be employed in many different embodiments or examples not specifically depicted or described herein. In some embodiments, the steps of method 200 can be performed in the order presented. In other embodiments, the steps of method 600 can be performed in any suitable order. In still other embodiments, one or more of the steps of method 600 can be combined or skipped. In many embodiments, system 100, legal service platform 140, and/or AI-powered solicitation system 150 can be configured to perform method 600 and/or one or more of the steps of method 600. In these or other embodiments, one or more of the steps of method 600 can be implemented as one or more computer instructions configured to run at one or more processing devices 102 and configured to be stored at one or more non-transitory computer storage devices 101. Such non-transitory memory storage devices 101 can be part of a computer system such as system 100, computing device(s) 110, server(s) 120, legal service platform 140, and/or AI-powered solicitation system 150.

In step 610, access to an AI-powered solicitation system is provided over a network, which includes a specification assembly engine 152, a matching engine 154, and a proposal synthesis engine 156 that are configured to communicate with one or more language models 164 in connection with implementing an electronic proposal solicitation process 151. In some embodiments, the AI-powered solicitation system also may include a proposal evaluation engine 159. Access may be provided to various end-users 105 including, but not limited to, requesting end-users seeking service proposals and/or service provider end-users that offer proposals. In embodiments that involve the solicitation of legal services, the end-users may include client end-users and legal end-users.

In step 620, a communication exchange is initiated between the specification assembly engine 152 of the AI-powered solicitation system 150 and the one or more language models 164 to generate a request specification 153 for a requesting end-user. In some examples, the request specification 153 may correspond to an RFP and, in other examples, the request specification 153 may correspond to an RFQ, RFI, and/or role placement request. The request specification 153 can apply to any type of service or industry including, but not limited to, legal services or legal industries.

In step 630, a communication exchange is initiated between the matching engine 154 of the AI-powered solicitation system 150 and the one or more language models 164 to generate a set of predicted candidate matches 250. In certain embodiments, the one or more language models identify the set of predicted candidate matches 250, at least in part, by determining an alignment between the request specification and candidate provider data corresponding to candidate service providers.

In step 640, a communication exchange is initiated between the proposal synthesis engine 156 of the AI-powered solicitation system 150 and the one or more language models 164 to generate one or more response proposals 157 for at least one service provider identified in the set of predicted candidate matches 250. In some embodiments, some or all of the candidate service providers identified in the set of predicted candidate matches 250 are provided access to the request proposal and are provided access to the functionalities of the proposal synthesis engine 156 for automating or streamlining the assembly or construction of corresponding response proposals 157.

In step 650, the one or more response proposals 157 are presented to the requesting end-user in connection with the electronic proposal solicitation process 151. In certain embodiments, the requesting end-user may access one or more front-end interfaces 145 that display a summary of the response proposals 157 and/or details of the response proposals 157. In certain embodiments, the one or more front-end interfaces 145 also may provide options that enable the requesting end-user to select or approve one or more of the received response proposals 157, and to enter into a smart contract with a service provider corresponding to each of the selected or approved response proposals 157.

In step 660, activities corresponding to the electronic proposal solicitation process 151 are recorded on one or more blockchain networks 130. In some examples, the legal service platform 140 and/or the decentralized network integration system 170 may communicate with the one or more blockchain networks 130 to record activities on a blockchain ledger including one or more of the following activities: establishing a procurement project 155 associated with the electronic proposal solicitation process 151 by the requesting end-user; creating, establishing, and/or disseminating the request specification 153 to service providers; creating and/or submitting response proposals 157 by the candidate service providers; selecting one or more service providers and/or approving one or more response proposals 157 by the requesting end-user; establishing one or more smart contract between the requesting end-user and one or more selected service providers; and/or interactions related to fulfilling obligations under the one or more established smart contracts.

In some embodiments, the method 600 also may include a step of storing documentation corresponding to the electronic proposal solicitation process 151, the procurement project 155, and/or the one or more established smart contracts on one or more distributed storage networks 135. This may include storing documentation corresponding to request specifications 153, response proposals 157, and/or the smart contracts on the one or more distributed storage networks 135.

As evidenced by the disclosure herein, the inventive techniques set forth in this disclosure are rooted in computer technologies that overcome existing problems in known proposal solicitation solutions, including problems dealing with the manual efforts at various stages of the solicitation process. The techniques described in this disclosure provide a technical solution (e.g., one that utilizes deep learning, NLP, and/or language model technologies) for overcoming the limitations associated with known techniques. This technology-based solution marks an improvement over existing capabilities and functionalities related to procuring proposals by streaming and improving the quality of content throughout the entire lifecycle of the solicitation process.

In many embodiments, the techniques described herein can be used continuously at a scale that cannot be reasonably performed using manual techniques or the human mind. For example, the functions performed by the AI architecture models, including those related to training on large datasets and/or analyzing large collections of data, cannot be performed in the human mind or with a paper and pencil.

Furthermore, in a number of embodiments, the techniques described herein can solve a technical problem that arises only within the realm of computer networks, because AI and machine learning technologies do not exist outside the realm of computer systems.

In certain embodiments, a system is provided for conducting an electronic proposal solicitation process. The system comprises one or more processing devices and one or more non-transitory storage devices for storing instructions. Execution of the instructions by the one or more processing devices causes the one or more processing devices to perform functions comprising: (a) providing access over a network to an AI-powered solicitation system, the AI-powered solicitation system comprising a specification assembly engine, a matching engine, and a proposal synthesis engine that are configured to communicate with one or more language models in connection with implementing an electronic proposal solicitation process; (b) initiating a communication exchange between the specification assembly engine of the AI-powered solicitation system and the one or more language models to generate a request specification for a requesting end-user; (c) initiating a communication exchange between the matching engine of the AI-powered solicitation system and the one or more language models to generate a set of predicted candidate matches, the one or more language models identifying the set of predicted candidate matches, at least in part, by determining an alignment between the request specification and candidate provider data corresponding to candidate service providers; (d) providing each candidate service provider corresponding to the set of predicted candidate matches with access to the request specification; (e) initiating a communication exchange between the proposal synthesis engine of the AI-powered solicitation system and the one or more language models to generate one or more response proposals for at least one candidate service provider identified in the set of predicted candidate matches; and (f) presenting the one or more response proposals to the requesting end-user in connection with the electronic proposal solicitation process.

In certain embodiments, the communication exchange between the matching engine of the AI-powered solicitation system and the one or more language models can include transmitting one or more prompts that cause the one or more language models to extract or derive selection criteria from the request specification for use in identifying the set of predicted candidate matches.

In certain embodiments, the selection criteria extracted or derived using the one or more language models can be utilized to assemble a benchmark profile corresponding to the request specification, wherein the benchmark profile may comprise a structured representation of attributes predicted to be optimal for identifying candidate service providers that are aligned with the request specification.

In certain embodiments, the matching engine may enforce a constrained contextual analysis on the one or more language models in connection with selecting or identifying the selection criteria, wherein the constrained contextual analysis can require the one or more language models to select at least a portion of the selection criteria from pre-defined categories of permissible attributes.

In certain embodiments, the communication exchange between the matching engine and the one or more language models can include transmitting one or more prompts that instruct the one or more language models to rank or order the set of predicted candidate matches based, at least in part, on performing a holistic assessment that considers all selection criteria corresponding to the request specification.

In certain embodiments, the communication exchange between the proposal synthesis engine and the one or more language models can include transmitting one or more prompts that cause the one or more language models to identify a plurality of proposal parameters for incorporation into the one or more response proposals and further cause the one or more language models to generate content for at least a portion of the plurality of proposal parameters.

In certain embodiments, the matching engine can execute a prioritized matching function that applies a multi-tiered search strategy to identify matching candidate service providers, wherein the prioritized matching function may initially attempt to perform direct matching on the candidate service providers and subsequently broaden search criteria if no direct matches are identified or a threshold number of matches is not satisfied.

In certain embodiments, the communication exchange between the specification assembly engine and the one or more language models can include transmitting one or more prompts that cause the one or more language models to extract specification parameters from contextual data describing or relating to services being solicited by the request specification and further cause the one or more language models to generate content for the specification parameters, wherein the contextual data utilized to extract the specification parameters may be obtained from one or more autonomous agents that are configured to autonomously extract data from web resources and/or platform profile data corresponding to the requesting end-user.

In certain embodiments, the one or more language models can be trained using a domain-specific dataset comprising data related to proposal solicitation processes, which may enhance the ability of the one or more language models to determine or select the specification parameters to be incorporated into the request specification.

In certain embodiments, the proposal synthesis engine can include a remuneration modeling engine that may be configured to predict a price and/or time requirement for a service corresponding to the request specification, wherein the proposal synthesis engine can include or communicate with one or more machine-learning models and/or the one or more language models to predict the price and/or the time requirement for the service.

In certain embodiments, the remuneration modeling engine can be further configured to generate or determine one or more alternative fee arrangements tailored to the request specification based, at least in part, on the predicted price and/or the predicted time requirement.

In certain embodiments, the requesting end-user can utilize the AI-powered solicitation system to solicit a plurality of response proposals from a plurality of legal service providers, wherein the request specification generated using the one or more language models can define a request for a legal service being solicited by the requesting end-user, and each of the one or more response proposals generated by the one or more language models can correspond to a legal service response proposal that is generated using the one or more language models, the one or more language models being configured to synthesize content for the legal service response proposal based on attributes of a corresponding legal service provider.

In certain embodiments, the request specification can correspond to at least one of: a request for proposal (RFP), a request for quotation (RFQ), a request for information (RFI), or a role placement request.

In certain embodiments, execution of the instructions by the one or more processing devices can further cause the one or more processing devices to perform functions comprising initiating a communication exchange between a proposal evaluation engine of the AI-powered solicitation system and the one or more language models to evaluate the one or more response proposals received from the at least one candidate service provider identified in the set of predicted candidate matches, wherein one or more prompts transmitted by the proposal evaluation engine can cause the one or more language models to output an updated ranking of the set of predicted candidate matches and/or output one or more selection recommendations corresponding to the request specification.

In certain embodiments, execution of the instructions by the one or more processing devices can further cause the one or more processing devices to perform functions comprising communicating with one or more blockchain networks to record data associated with the electronic proposal solicitation process, wherein a blockchain ledger associated with the one or more blockchain networks can at least record event data corresponding to a creation of the request specification by the requesting end-user and a selection or approval of a response proposal created by one of the candidate service providers.

In certain embodiments, execution of the instructions by the one or more processing devices can further cause the one or more processing devices to perform functions comprising communicating with one or more distributed storage networks to store documentation associated with the electronic proposal solicitation process, wherein the one or more distributed storage networks can at least store documentation corresponding to the request specification created for the requesting end-user and the one or more response proposals created for the at least one candidate service provider.

In certain embodiments, a method is provided for conducting an electronic proposal solicitation process. The method is implemented via the execution of computing instructions by one or more processing devices and stored on one or more non-transitory storage devices. The method comprises: (a) providing access over a network to an AI-powered solicitation system, the AI-powered solicitation system comprising a specification assembly engine, a matching engine, and a proposal synthesis engine that are configured to communicate with one or more language models in connection with implementing an electronic proposal solicitation process; (b) initiating a communication exchange between the specification assembly engine of the AI-powered solicitation system and the one or more language models to generate a request specification for a requesting end-user; (c) initiating a communication exchange between the matching engine of the AI-powered solicitation system and the one or more language models to generate a set of predicted candidate matches, the one or more language models identifying the set of predicted candidate matches, at least in part, by determining an alignment between the request specification and candidate provider data corresponding to candidate service providers; (d) providing each candidate service provider corresponding to the set of predicted candidate matches with access to the request specification; (e) initiating a communication exchange between the proposal synthesis engine of the AI-powered solicitation system and the one or more language models to generate one or more response proposals for at least one service provider identified in the set of predicted candidate matches; and (f) presenting the one or more response proposals to the requesting end-user in connection with the electronic proposal solicitation process.

In certain embodiments, a method is provided for conducting an electronic proposal solicitation process. The method is implemented via the execution of computing instructions by one or more processing devices and stored on one or more non-transitory storage devices. The method comprises: (a) providing access to an AI-powered solicitation system, the AI-powered solicitation system comprising a specification assembly engine, a matching engine, and a proposal synthesis engine that are configured to communicate with one or more language models in connection with implementing an electronic proposal solicitation process; (b) initiating a communication exchange between the specification assembly engine of the AI-powered solicitation system and the one or more language models to generate a request specification; (c) initiating a communication exchange between the matching engine of the AI-powered solicitation system and the one or more language models to identify a set of predicted candidate matches, the one or more language models identifying the set of predicted candidate matches, at least in part, by determining an alignment between the request specification and candidate provider data corresponding to candidate service providers; and (d) initiating a communication exchange between the proposal synthesis engine of the AI-powered solicitation system and the one or more language models to generate one or more response proposals for at least one service provider identified in the set of predicted candidate matches.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A system comprising one or more processing devices and one or more non-transitory storage devices for storing instructions, wherein execution of the instructions by the one or more processing devices causes the one or more processing devices to perform functions comprising:
providing access over a network to an AI-powered solicitation system, the AI-powered solicitation system comprising a specification assembly engine, a matching engine, and a proposal synthesis engine that are configured to communicate with one or more language models in connection with implementing an electronic proposal solicitation process;
initiating a communication exchange between the specification assembly engine of the AI-powered solicitation system and the one or more language models to generate a request specification for a requesting end-user;
initiating a communication exchange between the matching engine of the AI-powered solicitation system and the one or more language models to generate a set of predicted candidate matches, the one or more language models identifying the set of predicted candidate matches, at least in part, by determining an alignment between the request specification and candidate provider data corresponding to candidate service providers;
providing each candidate service provider corresponding to the set of predicted candidate matches with access to the request specification;
initiating a communication exchange between the proposal synthesis engine of the AI-powered solicitation system and the one or more language models to generate one or more response proposals for at least one candidate service provider identified in the set of predicted candidate matches; and
presenting the one or more response proposals to the requesting end-user in connection with the electronic proposal solicitation process.

2. The system of claim 1, wherein the communication exchange between the matching engine of the AI-powered solicitation system and the one or more language models includes transmitting one or more prompts which cause the one or more language models to extract or derive selection criteria from the request specification for usage in identifying the set of predicted candidate matches.

3. The system of claim 2, wherein the selection criteria extracted or derived using the one or more language models is utilized to assemble a benchmark profile corresponding to the request specification, wherein the benchmark profile comprises a structured representation of attributes predicted to be optimal for identifying the candidate service providers that are aligned with the request specification.

4. The system of claim 2, wherein the matching engine enforces a constrained contextual analysis on the one or more language models in connection with selecting or identifying the selection criteria, the constrained contextual analysis requiring the one or more language models to select at least a portion of the selection criteria from pre-defined categories of permissible attributes.

5. The system of claim 1, wherein the communication exchange between the matching engine and the one or more language models includes transmitting one or more prompts which instruct the one or more language models to rank or order the set of predicted candidate matches based, at least in part, on performing a holistic assessment that considers all selection criteria corresponding to the request specification.

6. The system of claim 1, wherein the communication exchange between the proposal synthesis engine and the one or more language models includes transmitting one or more prompts which cause the one or more language models to identify a plurality of proposal parameters for incorporation into the one or more response proposals and further cause the one or more language models to generate content for at least a portion of the plurality of proposal parameters.

7. The system of claim 1, wherein the matching engine executes a prioritized matching function that applies a multi-tiered search strategy to identify matching candidate service providers, wherein the prioritized matching function initially attempts to perform direct matching on the candidate service providers, and subsequently broadens search criteria if no direct matches are identified or a threshold number of matches is not satisfied.

8. The system of claim 1, wherein:
the communication exchange between the specification assembly engine and the one or more language models includes transmitting one or more prompts which cause the one or more language models to extract specification parameters from contextual data describing or relating to services being solicited by the request specification and which further cause the one or more language models to generate content for the specification parameters; and
the contextual data utilized to extract the specification parameters is obtained from one or more autonomous agents that are configured to autonomously extract data from web resources and/or platform profile data corresponding to the requesting end-user.

9. The system of claim 8, wherein the one or more language models are trained using a domain-specific dataset comprising data related to proposal solicitation processes that enhance an ability of the one or more language models to determine or select the specification parameters to be incorporated into the request specification.

10. The system of claim 1, wherein:
the proposal synthesis engine comprises a remuneration modeling engine that is configured to predict a price and/or time requirement for a service corresponding to the request specification; and
the proposal synthesis engine includes or communicates with one or more machine-learning models and/or the one or more language models to predict the price and/or the time requirement for the service.

11. The system of claim 10, wherein the remuneration modeling engine is further configured to generate or determine one or more alternative fee arrangements tailored to the request specification based, at least in part, on the predicted price and/or the predicted time requirement.

12. The system of claim 1, wherein:
the requesting end-user utilizes the AI-powered solicitation system to solicit a plurality of response proposals from a plurality of legal service providers;
the request specification generated using the one or more language models defines a request for a legal service being solicited by the requesting end-user; and
each of the one or more response proposals generated by the one or more language models corresponds to a legal service response proposal that is generated using the one or more language models, the one or more language models being configured to synthesize content for the legal service response proposal based on attributes of a corresponding legal service provider.

13. The system of claim 1, wherein the request specification corresponds to at least one of: a request for proposal (RFP), a request for quotation (RFQ), a request for information (RFI), or a role placement request.

14. The system of claim 1, wherein execution of the instructions by the one or more processing devices further causes the one or more processing devices to perform functions comprising:
initiating a communication exchange between a proposal evaluation engine of the AI-powered solicitation system and the one or more language models to evaluate the one or more response proposals received from the at least one candidate service provider identified in the set of predicted candidate matches, wherein one or more prompts transmitted by the proposal evaluation engine cause the one or more language models to output an updated ranking of the set of predicted candidate matches and/or output one or more selection recommendations corresponding to the request specification.

15. The system of claim 1, wherein execution of the instructions by the one or more processing devices further causes the one or more processing devices to perform functions comprising:
communicating with one or more blockchain networks to record data associated with the electronic proposal solicitation process, wherein a blockchain ledger associated with the one or more blockchain networks at least records event data corresponding to a creation of the request specification by the requesting end-user, and a selection or approval of a response proposal created by one of the candidate service providers.

16. The system of claim 1, wherein execution of the instructions by the one or more processing devices further causes the one or more processing devices to perform functions comprising:
communicating with one or more distributed storage networks to store documentation associated with the electronic proposal solicitation process, wherein the one or more distributed storage networks at least store documentation corresponding to the request specification created for the requesting end-user, and the one or more response proposals created for the at least one candidate service provider.

17. A method implemented via execution of computing instructions by one or more processing devices and configured to be stored on one or more non-transitory storage devices, the method comprising:
providing access over a network to an AI-powered solicitation system, the AI-powered solicitation system comprising a specification assembly engine, a matching engine, and a proposal synthesis engine that are configured to communicate with one or more language models in connection with implementing an electronic proposal solicitation process;
initiating a communication exchange between the specification assembly engine of the AI-powered solicitation system and the one or more language models to generate a request specification for a requesting end-user;
initiating a communication exchange between the matching engine of the AI-powered solicitation system and the one or more language models to generate a set of predicted candidate matches, the one or more language models identifying the set of predicted candidate matches, at least in part, by determining an alignment between the request specification and candidate provider data corresponding to candidate service providers;
providing each candidate service provider corresponding to the set of predicted candidate matches with access to the request specification;
initiating a communication exchange between the proposal synthesis engine of the AI-powered solicitation system and the one or more language models to generate one or more response proposals for at least one service provider identified in the set of predicted candidate matches; and
presenting the one or more response proposals to the requesting end-user in connection with the electronic proposal solicitation process.

18. A method implemented via execution of computing instructions by one or more processing devices and configured to be stored on one or more non-transitory storage devices, the method comprising:
providing access to an AI-powered solicitation system, the AI-powered solicitation system comprising a specification assembly engine, a matching engine, and a proposal synthesis engine that are configured to communicate with one or more language models in connection with implementing an electronic proposal solicitation process;
initiating a communication exchange between the specification assembly engine of the AI-powered solicitation system and the one or more language models to generate a request specification;
initiating a communication exchange between the matching engine of the AI-powered solicitation system and the one or more language models to identify a set of predicted candidate matches, the one or more language models identifying the set of predicted candidate matches, at least in part, by determining an alignment between the request specification and candidate provider data corresponding to candidate service providers; and
initiating a communication exchange between the proposal synthesis engine of the AI-powered solicitation system and the one or more language models to generate one or more response proposals for at least one service provider identified in the set of predicted candidate matches.
